(19) United States
(12) Patent Application Publication
(10) Pub. No.: US 2017/0166108 A1
(43) Pub. Date: Jun. 15, 2017

(54) AUXILIARY DYNAMIC LIGHT AND CONTROL SYSTEM

(71) Applicant: TMW Consulting LLC, North Ogden, UT (US)

(72) Inventors: Mitch Warren, North Ogden, UT (US); John Carl Lagerquist, Pleasant View, UT (US)

(73) Assignee: TMW Consulting LLC, North Ogden, UT (US)

(21) Appl. No.: 15/346,809

(22) Filed: Nov. 9, 2016

Related U.S. Application Data
(60) Provisional application No. 62/267,750, filed on Dec. 15, 2015.

(51) Int. Cl. B60Q 1/08; F21S 8/10

(52) U.S. Cl. CPC B60Q 1/08; F21S 48/1109

(57) ABSTRACT

An active or dynamic light control system is adapted for aftermarket retrofitting to vehicles. The system includes a directional sensor configured to sense direction of the vehicle. A control unit is operatively connected to the directional sensor to receive the direction of the vehicle from the directional sensor. A light pod is operatively connected to the control unit. The light pod includes an illumination element configured to provide light. The light pod is configured to change direction of the light from the illumination element in response to a signal received from the control unit based at least in part on the direction of the vehicle sensed by the direction sensor.

### CROSS-REFERENCE TO RELATED APPLICATION

This application claims the benefit of U.S. Provisional Application No. 62/267,750 filed Dec. 15, 2015, which is hereby incorporated by reference.

### BACKGROUND

The present invention relates to the field of automotive lighting control technology, particularly to an active-type headlight control.

Vehicular headlights are generally mounted in a more or less stationary orientation at or near the front of the vehicle from which position they illuminate the area immediately in front of the vehicle body. Hence, if the vehicle is oriented in a direction that is more or less parallel to the road surface immediately ahead of it, the headlights will effectively illuminate the road ahead of the vehicle. However, if the vehicle is oriented in a direction that is not more or less parallel to the road surface immediately ahead of the vehicle, such as when the vehicle rounds a corner or crests a hill, the headlights shine in a direction other than the direction the vehicle is travelling. This results in the driver being essentially being blind as to what lies immediately in front of the vehicle until the vehicle resumes a path that is more or less parallel with the direction of the road.

Thus, it would be useful to have a headlight system that could orient the direction of the headlights to always illuminate the road in the direction the vehicle is traveling. It would also be useful if the headlight system could orient itself along a horizontal as well as vertical axis of rotation. Finally, it would be useful if the speed at which the headlight system changes the orientation of the headlights was calibrated to the speed of the vehicle such that the faster the vehicle is moving, the faster the headlights move to match the direction of travel.

Thus, there is a need for improvement in this field.

### SUMMARY

The current disclosure deals with an active type headlight control system that can adjust a headlight directional orientation according to the orientation of the vehicle with regard to the present road surface or off road terrain, along with the running state of a motor vehicle. The active type headlight control system as described and claimed below comprises a plurality of data collectors that collect information on the orientation of the front wheels, the angle of the vehicle with regard to level, and, in some instances, the speed of the vehicle. The data collectors relay that information to a processor that analyses the information according to a set of algorithms and generates a signal to govern the movement of a headlight actuator based on the analysis of the information from the data collector. The signal is in turn relayed to an actuator that controls the directional orientation of the headlight.

Many pre-existing vehicles have fixed lights that are unable to redirect the light shone. The auxiliary dynamic light and control system described and illustrated herein is designed to be easily retrofitted to pre-existing vehicles. Moreover, it has the ability to allow the operator to control the position, direction, and speed of movement of the lights shone from the system remotely through a mobile device. As will be explained in greater detail below, a mobile device, such as a cell or smart phone, can be used to redirect the lights to a particular area of interest even when an individual is outside of the cabin of the vehicle which can be useful in a number of situations. For example, the individual via the smart phone can direct the light onto a particular piece of equipment or area of land that they are inspecting when it is dark. In one variation, the mobile device includes a wearable device that is placed on the head of an individual so that the lights can track the movement of the individual's head so that wherever the individual is looking is generally lit. The system is configured to use a slew rate filter to reduce sudden movements of the lights due to rapid changes in acceleration or deceleration, such as during sudden braking, bumps, etc.

Aspect 1 concerns a system, comprising a directional sensor configured to sense direction of a vehicle a control unit operatively connected to the directional sensor to receive the direction of the vehicle from the directional sensor; and a light pod operatively connected to the control unit, wherein the light pod includes an illumination element configured to provide light, wherein the light pod is configured to change direction of the light from the illumination element in response to a signal received from the control unit based at least in part on the direction of the vehicle sensed by the direction sensor.

Aspect 2 concerns the system of aspect 1, further comprising the vehicle, wherein the vehicle has at least one headlight installed when the vehicle was originally manufactured; and the light pod is separate from the headlight and attached after the vehicle was manufactured.

Aspect 3 concerns the system of aspect 2, wherein the control unit is attached to the vehicle after the vehicle was originally manufactured.

Aspect 4 concerns the system of aspect 1, wherein the light pod includes a gimbal to which the illumination element is secured, a pitch actuator to pivot the illumination element in the gimbal in a pitch direction, and a yaw actuator configured to pivot the illumination element in the gimbal in a yaw direction.

Aspect 5 concerns the system of aspect 4, wherein the control unit is configured to activate the yaw actuator based at least in part on the direction of the vehicle sensed by the direction sensor.

Aspect 6 concerns the system of aspect 4, further comprising an accelerometer/gyroscope operatively connected to the control unit to monitor acceleration of the vehicle; and wherein the control unit is configured to adjust a slew rate of a signal sent to the pitch actuator upon the accelerometer/gyroscope sensing a rapid acceleration or deceleration to reduce sudden movement of the light from the light pod.

Aspect 7 concerns the system of aspect 1, further comprising a speed sensor operatively connected to the control unit to sense speed of the vehicle; and wherein the control unit is configured to adjust a rate at which the direction of the light moves based on the speed from the speed sensor.

Aspect 8 concerns the system of aspect 7, further comprising a bus of the vehicle; and wherein the speed sensor and the control unit are operatively connected via the bus.

Aspect 9 concerns the system of aspect 1, further comprising a main harness operatively connecting the directional sensor and the light pod to the control unit.

Aspect 10 concerns the system of aspect 9, further comprising a power source of the vehicle; and wherein the main harness operatively connects the control unit to the power source of the vehicle to at least power the control unit and the light pod.

Aspect 11 concerns the system of aspect 1, wherein the control unit is integrated into the light pod.

Aspect 12 concerns the system of aspect 1, further comprising wherein the light pod is a first light pod; and a second light pod operatively connected to the control unit.

Aspect 13 concerns the system of aspect 12, wherein the second light pod is daisy chained to the first light pod.

Aspect 14 concerns the system of aspect 12, further comprising a pod harness operatively connecting the first light pod to the second light pod.

Aspect 15 concerns the system of aspect 12, wherein the first light pod is configured to control the second light pod.

Aspect 16 concerns the system of claim 12, wherein the first light pod and the second light pod are independently controllable.

Aspect 17 concerns the system of aspect 1, wherein the light pod include a gyroscope to correct light movement independently of mounting orientation of the light pod.

Aspect 18 concerns the system of aspect 1, wherein the control unit includes an input device to manually control the direction of the light from the light pod.

Aspect 19 concerns the system of aspect 1, further comprising a transceiver operatively connected to the control unit; and a mobile device wirelessly communicating with the control unit via the wireless transceiver.

Aspect 20 concerns the system of aspect 19, wherein the mobile device includes a cellphone configured to facilitate manual control of the light from the light pod.

Aspect 21 concerns the system of aspect 19, wherein the mobile device is configured to be worn on a head of an individual; and the control unit is configured to change the direction of the light from the light pod based at least in part on movement of the head sensed by the mobile device.

Aspect 22 concerns the system of aspect 1, wherein the directional sensor includes a cable-extension transducer.

Aspect 23 concerns the system of aspect 22, further comprising a steering shaft of the vehicle; and wherein the directional sensor includes a steering coupler coupled to the steering shaft, and a cable extending between the steering coupler and the cable-extension transducer.

Aspect 24 concerns the system of aspect 1, further comprising an input device to select a sensitivity level; and the control unit is configured to adjust a rate at which the direction of the light is change at least based on the sensitivity level.

Aspect 25 concerns a method, comprising receiving a wireless signal from a mobile device indicating a direction of light with a control unit; and changing the direction of the light shown from a light pod attached to a vehicle based on said receiving the wireless signal.

Aspect 26 concerns the method of aspect 25, further comprising wherein the mobile device includes a wearable sensor worn on a head of an individual; and wherein said changing the direction of the light includes synchronizing movement of the light from the light pod based on movement of the head sensed by the wearable sensor.

Aspect 27 concerns the method of aspect 25, further comprising wherein the mobile device includes a cell phone; and wherein said changing the direction of the light includes moving the light from the light pod based on movement of the cell phone.

Aspect 28 concerns the method of aspect 25, further comprising wherein the mobile device includes an input device; and wherein said changing the direction of the light includes moving the light from the light pod based on signals from the input device of the mobile device.

Aspect 29 concerns a method, comprising shining light with a light pod attached to a vehicle, wherein the light pod is operatively connected to a control unit that is operatively connected to an accelerometer detecting a motion of the vehicle with the control unit through the accelerometer changing the direction of the light shown from the light pod based on said detecting by sending a signal from the control unit to the light pod; determining the motion of the vehicle exceeds a threshold with the control unit; and adjusting a rate of change of the direction of the light shown from the light pod based on said determining.

Aspect 30 concerns the method of aspect 29, wherein said determining the motion of the vehicle includes determining the accelerometer is in a nominal state determining an absolute value of acceleration of the accelerometer exceeds an active threshold limit; setting a maximum slew rate to a calibrated maximum slew rate; and wherein said adjusting the rate includes limiting the rate based on the maximum slew rate.

Aspect 31 concerns the method of aspect 29, wherein said determining the motion of the vehicle includes determining the accelerometer is not in a nominal state determining an absolute value of acceleration of the accelerometer exceeds an inactive threshold limit; setting a maximum slew rate to a calibrated maximum slew rate; and wherein said adjusting the rate includes limiting the rate based on the maximum slew rate.

Aspect 32 concerns the method of aspect 29, wherein said determining the motion of the vehicle includes determining the accelerometer is not in a nominal state determining an absolute value of acceleration of the accelerometer is less than or equal to an inactive threshold limit; and setting a state of slew rate control to inactive.

Aspect 33 concerns the method of aspect 29, further comprising receiving with the control unit a sensitivity control signal; and adjusting the rate of change of the direction of the light shown from the light pod based on the sensitivity control signal.

Aspect 34 concerns the method of aspect 29, further comprising determining a mounting orientation of the light pod with a gyroscope in the light pod; and correcting movement the light shone from the light pod based on said determining the mounting orientation.

Aspect 35 concerns the method of aspect 29, wherein the control unit is integrated into the light pod.

Aspect 36 concerns a method, comprising shining light with a first light pod and a second light pod that are attached to a vehicle; controlling the light shone from the first light pod with the first light pod independently of the second light pod; and controlling the light shone from the second light pod with the second light pod independently of the first light pod.

Aspect 37 concerns the method of aspect 36, wherein said controlling the light shone from the first light pod includes changing direction of the light shone from the first light pod.

Aspect 38 concerns the method of aspect 36, wherein said controlling the light shone from the first light pod includes changing directional movement of the light shone from the first light pod.

Aspect 39 concerns the method of aspect 36, further comprising determining a mounting orientation of the second light pod with the second light pod; and correcting movement the light shone from the second light pod based on said determining the mounting orientation.

Aspect 40 concerns the system of any preceding claim, wherein the light pod includes a gimbal to which the illumination element is secured, a pitch actuator to pivot the illumination element in the gimbal in a pitch direction, and a yaw actuator configured to pivot the illumination element in the gimbal in a yaw direction.

Aspect 41 concerns the system of any preceding claim, wherein the control unit is configured to activate the yaw actuator based at least in part on the direction of the vehicle sensed by the direction sensor.

Aspect 42 concerns the system of any preceding claim, further comprising an accelerometer/gyroscope operatively connected to the control unit to monitor acceleration of the vehicle; and wherein the control unit is configured to adjust a slew rate of a signal sent to the pitch actuator upon the accelerometer/gyroscope sensing a rapid acceleration or deceleration to reduce sudden movement of the light from the light pod.

Aspect 43 concerns the system of any preceding claim, further comprising a speed sensor operatively connected to the control unit to sense speed of the vehicle; and wherein the control unit is configured to adjust a rate at which the direction of the light moves based on the speed from the speed sensor.

Aspect 44 concerns the system of any preceding claim, further comprising a bus of the vehicle; and wherein the speed sensor and the control unit are operatively connected via the bus.

Aspect 45 concerns the system of any preceding claim, further comprising a main harness operatively connecting the directional sensor and the light pod to the control unit.

Aspect 46 concerns the system of any preceding claim, further comprising a power source of the vehicle; and wherein the main harness operatively connects the control unit to the power source of the vehicle to at least power the control unit and the light pod.

Aspect 47 concerns the system of any preceding claim, wherein the control unit is integrated into the light pod.

Aspect 48 concerns the system of any preceding claim, further comprising wherein the light pod is a first light pod; and a second light pod operatively connected to the control unit.

Aspect 49 concerns the system of any preceding claim, wherein the second light pod is daisy chained to the first light pod.

Aspect 50 concerns the system of any preceding claim, further comprising a pod harness operatively connecting the first light pod to the second light pod.

Aspect 51 concerns the system of any preceding claim, wherein the first light pod is configured to control the second light pod.

Aspect 52 concerns the system of any preceding claim, wherein the first light pod and the second light pod are independently controllable.

Aspect 53 concerns the system of any preceding claim, wherein the light pod include a gyroscope to correct light movement independently of mounting orientation of the light pod.

Aspect 54 concerns the system of any preceding claim, wherein the control unit includes an input device to manually control the direction of the light from the light pod.

Aspect 55 concerns the system of any preceding claim, further comprising a transceiver operatively connected to the control unit; and a mobile device wirelessly communicating with the control unit via the wireless transceiver.

Aspect 56 concerns the system of aspect 19, wherein the mobile device includes a cellphone configured to facilitate manual control of the light from the light pod.

Aspect 57 concerns the system of any preceding claim, wherein the mobile device is configured to be worn on a head of an individual; and the control unit is configured to change the direction of the light from the light pod based at least in part on movement of the head sensed by the mobile device.

Aspect 58 concerns a system of any preceding claim, wherein the directional sensor includes a cable-extension transducer.

Aspect 59 concerns the system of any preceding claim, further comprising a steering shaft of the vehicle; and wherein the directional sensor includes a steering coupler coupled to the steering shaft, and a cable extending between the steering coupler and the cable-extension transducer.

Aspect 60 concerns the system of any preceding claim, further comprising an input device to select a sensitivity level; and the control unit is configured to adjust a rate at which the direction of the light is change at least based on the sensitivity level.

Aspect 61 concerns the method of any preceding claim, further comprising wherein the mobile device includes a wearable sensor worn on a head of an individual; and wherein said changing the direction of the light includes synchronizing movement of the light from the light pod based on movement of the head sensed by the wearable sensor.

Aspect 62 concerns the method of any preceding claim, further comprising wherein the mobile device includes a cell phone; and wherein said changing the direction of the light includes moving the light from the light pod based on movement of the cell phone.

Aspect 63 concerns the method of any preceding claim, further comprising wherein the mobile device includes an input device; and wherein said changing the direction of the light includes moving the light from the light pod based on signals from the input device of the mobile device.

Aspect 64 concerns the method of any preceding claim, wherein said determining the motion of the vehicle includes determining the accelerometer is in a nominal state determining an absolute value of acceleration of the accelerometer exceeds an active threshold limit; setting a maximum slew rate to a calibrated maximum slew rate; and wherein said adjusting the rate includes limiting the rate based on the maximum slew rate.

Aspect 65 concerns the method of any preceding claim, wherein said determining the motion of the vehicle includes determining the accelerometer is not in a nominal state determining an absolute value of acceleration of the accelerometer exceeds an inactive threshold limit; setting a maximum slew rate to a calibrated maximum slew rate; and wherein said adjusting the rate includes limiting the rate based on the maximum slew rate.

Aspect 66 concerns the method of any preceding claim, wherein said determining the motion of the vehicle includes determining the accelerometer is not in a nominal state determining an absolute value of acceleration of the accelerometer is less than or equal to an inactive threshold limit; and setting a state of slew rate control to inactive.

Aspect 67 concerns the method of any preceding claim, further comprising receiving with the control unit a sensitivity control signal; and adjusting the rate of change of the direction of the light shown from the light pod based on the sensitivity control signal.

Aspect 68 concerns the method of any preceding claim, further comprising determining a mounting orientation of the light pod with a gyroscope in the light pod; and correcting movement the light shone from the light pod based on said determining the mounting orientation.

Aspect 69 concerns the method of any preceding claim, wherein the control unit is integrated into the light pod.

Aspect 70 concerns the method of any preceding claim, wherein said controlling the light shone from the first light pod includes changing direction of the light shone from the first light pod.

Aspect 71 concerns the method of any preceding claim, wherein said controlling the light shone from the first light pod includes changing directional movement of the light shone from the first light pod.

Aspect 72 concerns the method of any preceding claim, further comprising determining a mounting orientation of the second light pod with the second light pod; and correcting movement the light shone from the second light pod based on said determining the mounting orientation.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a block diagram of an active or dynamic light control system.

FIG. 2 is a block diagram of one particular implementation of the FIG. 1 system that includes a head position tracking device.

FIG. 3 is a diagram illustrating the operation of the FIG. 2 head position tracking device.

FIG. 4 is a block diagram illustrating the harness connections for the FIG. 1 system.

FIG. 5 is an exploded view of a vehicular system incorporating the FIG. 1 system.

FIG. 6 is a front perspective view of a control unit for the FIG. 1 system.

FIG. 7 is a rear perspective view of the FIG. 6 control unit.

FIG. 8 is a front view of the FIG. 6 control unit.

FIG. 9 is an exploded view of the FIG. 6 control unit.

FIG. 10 is a perspective view of an accelerometer/gyroscope for the FIG. 1 system.

FIG. 11 is a wiring schematic of the connections inside the FIG. 6 control unit.

FIG. 12 is a top view of a main harness for the FIG. 1 system.

FIG. 13 is a wiring schematic of the FIG. 12 main harness.

FIG. 14 is a front perspective view of one example of a directional sensor for the FIG. 1 system.

FIG. 15 is a rear perspective view of the FIG. 14 directional sensor attached to a steering shaft.

FIG. 16 is an exploded view of the FIG. 14 directional sensor.

FIG. 17 is an enlarged exploded view of one portion of the FIG. 14 directional sensor.

FIG. 18 is a perspective view of another example of a directional sensor for the FIG. 1 system.

FIG. 19 is a front perspective view of a dynamic light pod for the FIG. 1 system.

FIG. 20 is a rear perspective view of the FIG. 19 dynamic light pod.

FIG. 21 is an exploded view of the FIG. 19 dynamic light pod.

FIG. 22 is a top view of the FIG. 19 dynamic light pod with its housing removed.

FIG. 23 is a side view of the FIG. 19 dynamic light pod with its housing removed.

FIG. 24 is a rear view of the FIG. 19 dynamic light pod.

FIG. 25 is a top view of a pod harness for the FIG. 19 dynamic light pod.

FIG. 26 is a wiring schematic of the FIG. 25 pod harness.

FIG. 27 is a flow diagram illustrating one technique for operating the FIG. 1 system.

FIG. 28 is a flow diagram illustrating one technique for adapting the slew rate for movement of the light beams in the FIG. 1 system.

FIG. 29 is a block diagram illustrating the harness connections for another active or dynamic light control system.

FIG. 30 is a block diagram of a dynamic light pod used in the FIG. 29 system.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. While the present disclosure is described with respect to what is presently considered to be exemplary embodiments, it is understood that the disclosure is not limited to the disclosed embodiments. Furthermore, it is understood that this disclosure is not limited to the particular methodology, materials and modifications described and as such may, of course, vary. Any alterations and further modifications in the described embodiments, and any further applications of the principles of the invention as described herein are contemplated as would normally occur to one skilled in the art to which the invention relates.

One embodiment of the invention is shown in great detail, although it will be apparent to those skilled in the relevant art that some features that are not relevant to the present invention may not be shown for the sake of clarity. It is also understood that the terminology used herein is for the purpose of describing particular aspects only, and is not intended to limit the scope of the present disclosure, which is limited only by the appended claims. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the preferred methods, devices, and materials are now described.

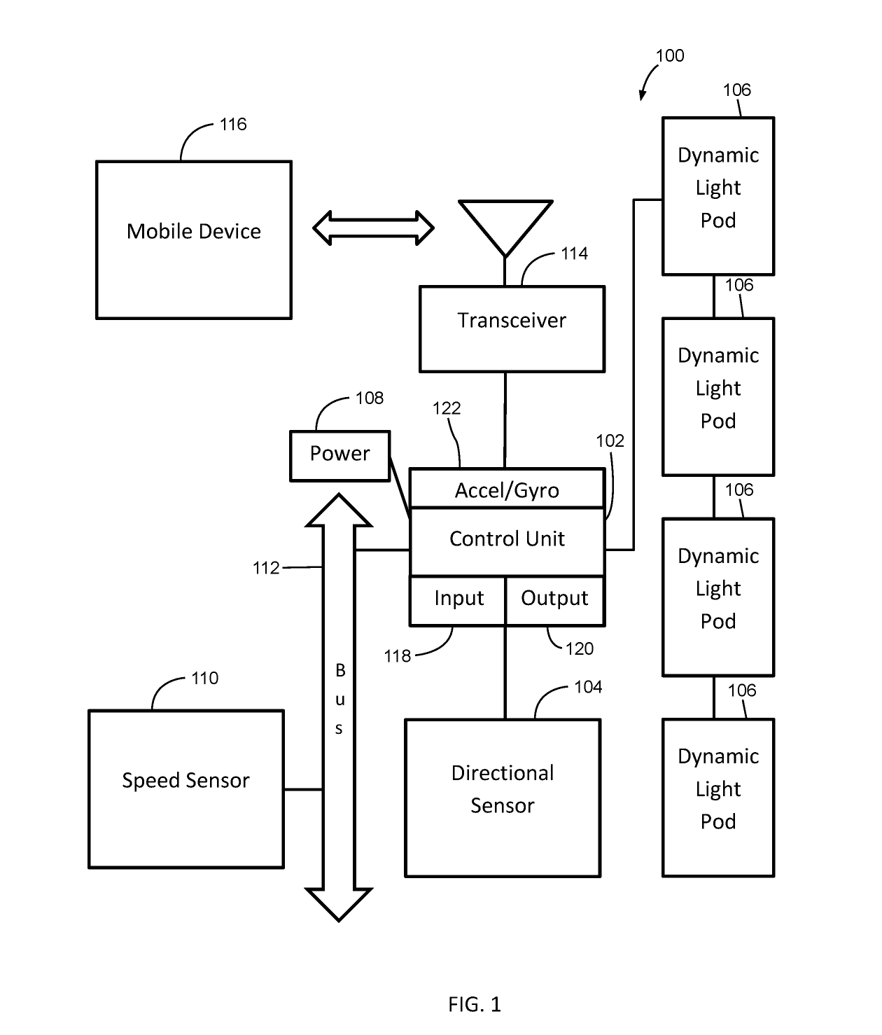

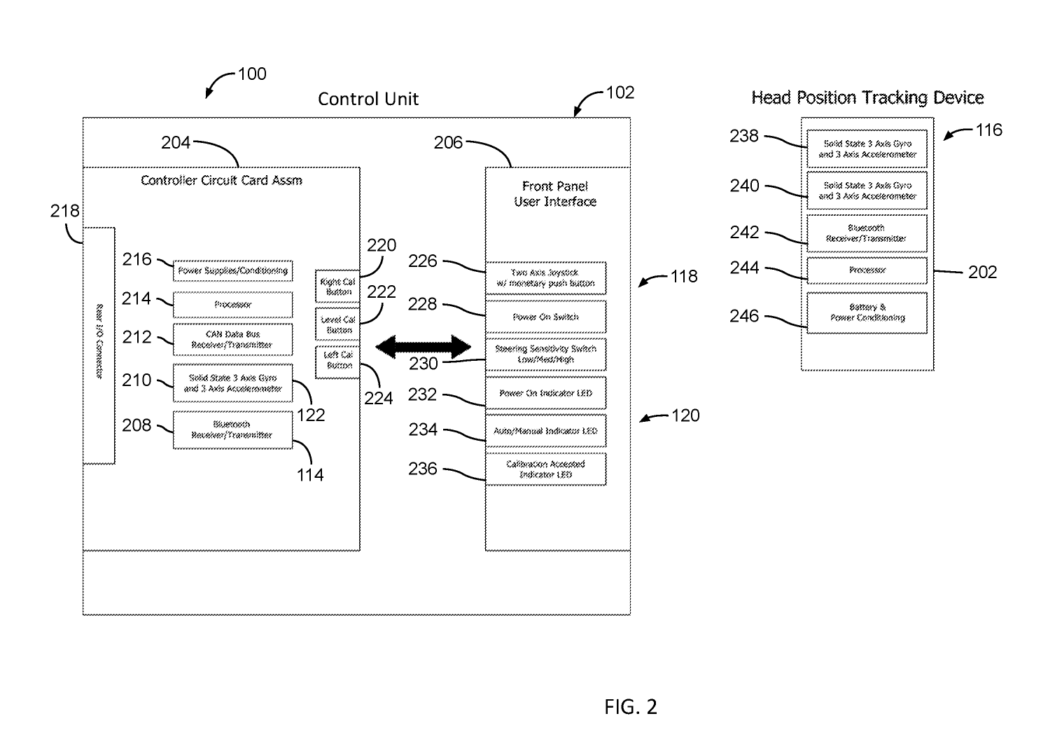

At the outset, it should be appreciated that like drawing numbers on different views identify identical structural elements of the disclosure. The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

A block diagram of an active or dynamic light control system 100 is depicted in FIG. 1. As will be explained below, the system 100 is designed to be easily retrofitted into pre-existing vehicles, and typically, but not always, supplements lighting preinstalled on the vehicle. In other words, the dynamic light control system 100 acts as an auxiliary lighting system for the vehicle. In other examples, the system 100 can act as the primary lighting system for the vehicle. As shown, the system 100 includes at least one control unit 102, at least one directional sensor 104, and one or more dynamic light pods 106 that are operatively connected together. Based on the steering angle from the directional sensor 104 as well as other inputs, the control unit 102 controls the angular orientation of the light beams from the dynamic light pods 106 both in the vertical and horizontal directions.

The directional sensor 104 gathers information regarding the orientation of the vehicle with respect to a normal direction. As used herein, the term “normal” refers to a direction that is more or less parallel to the longitudinal axis of the vehicle. In one embodiment, the directional sensor 104 gathers information directly by monitoring the angle of the front wheels with respect to normal. The directional sensor 104 converts the information regarding the orientation of a vehicle 502 with respect to normal into an electrical signal that represents the angle of the front wheels with respect to normal. The directional sensor 104 is in communication with a processor 214 located within the control unit 102. This communication may be accomplished via a direct electronic link between the at least one electrical sensor and processor as with a wire or a cable. This communication may also be accomplished via an electromagnetic link as with Radio Frequency (RF) or BLUETOOTH® communication.

To help simplify installation or retrofitting, the dynamic light pods 106 are configured to be daisy-chained together. In one form, up to 5 dynamic light pods 106 can be daisy-chained together, but in other examples, more or less dynamic light pods 106 can be connected together. As shown, the system 100 further includes a power source 108 that provides power to the control unit 102 as well as other components of the system 100, such as the directional sensor 104 and the dynamic light pods 106. In one variation, the power source 108 is provided by the pre-existing electrical power from the vehicle itself, but in other variations, the power source 108 can be independent of the vehicle (e.g., a separate battery pack, solar cells, etc.).

In the illustrated example, the control unit 102 is operatively connected to a speed sensor 110 of the vehicle via a vehicle communication bus or Controller Area Network (CAN) bus 112. The speed sensor 110 measures the speed of the vehicle, and the vehicle communication bus 112 is a specialized internal communications network that interconnects components inside a vehicle. In another example, the signal generated by the speed sensor 110 is fed directly into the processor of the control unit 102 via the wire that carries the signal generated by the speed sensor 110. In a further example, the capture of the signal generated by the speed sensor 110 is accomplished by a wire coil placed around the wire that carries the speed signal. The current in the wire carrying the speed signal of the vehicle induces a current in the wire coil. The wire coil intercepts electronic communication with a processor via a wire or a cable. In still yet another example, the wire coil may be in electronic communication with a speed processor that converts the current in the wire coil to a digital signal. The speed processor is in electronic communication with the processor in the control unit 102. This communication may be accomplished via a direct electronic link between the sensor and processor as with a wire or a cable. This communication may also be accomplished via an electromagnetic link as with RF and/or BLUETOOTH® communication. Through the speed sensor 110, the control unit 102 can determine the current speed of the vehicle so as to control the rate at which the dynamic light pods 106 are moved. For instance, if the vehicle is traveling at a slow speed, one or more of the dynamic light pods 106 can be repositioned at a slower speed to coincide with the speed of the vehicle, and when the vehicle is moving fast, the dynamic light pods 106 can be rapidly reoriented. The speed sensor 110 in the illustrated example is the standard speed sensor found in the vehicle, but in other examples, the speed sensor 110 can be retrofitted along with the rest of the system 100.

With continued reference to FIG. 1, the system 100 further includes a wireless transceiver 114 that wirelessly communicates with a mobile device 116. In the illustrated example, the transceiver 114 is illustrated as being a separate component from the control unit 102, but in other examples, the transceiver 114 can be integrated into the control unit 102. A mobile device 116 can come in many forms, such as a smart phone, personal wearable device, laptop, and the like. In one example, the mobile device 116 is a smart phone that acts as an interface with the control unit 102 to allow the driver (or others) to control the relative position of light beams emitted by one or more of the dynamic light pods 106. For instance, via an app on the smart phone, a person can control the dynamic light pods 106 even when they are not in the vehicle to shine light in an area of interest or where they are standing. In another example, which will be described in greater detail below, the mobile device 116 includes a wearable device attached to or integrated into a hat or other article worn on the head of the driver of the vehicle (or other individuals) so that the control unit 102 can track the position of the driver's head and accordingly orient the light beams so as to generally coincide to where the driver is looking. In another example, the mobile device is a cellphone that has its own accelerometer. Based on the direction, motion, and/or orientation of the cellphone, the light shown from the dynamic light pods 106 tracks or synchronizes with that of the cellphone. The dynamic light pods 106 shine light on wherever the cellphone points to such that the cellphone (or other mobile device 116) acts as a virtual or remote controlled flashlight or spotlight. In one form, the mobile device 116 communicates with the transceiver 114 via a BLUETOOTH® type connection, but the transceiver 114 and the mobile device 116 can wirelessly communicate using other protocols and/or connections, such as via a Wi-Fi and/or cellular connection.

The control unit 102 in FIG. 1 includes an input device 118, an output device 120, and an accelerometer/gyroscope 122. The input device 118 allows the operator to interface with the control unit 102, and the input device 118 can include any number of input devices, such as buttons, switches, touchscreens, and/or voice input devices, to identify just a couple of examples. The output device 120 is configured to provide information to the operator, such as related to the operational state of the system 100 and feedback to actuation of an input device. The output device 120 can come in any number of forms. By way of non-limiting examples, the output device 120 can include light emitting diodes (LEDs), displays, speakers, and/or tactile interfaces, to name just a few. In the illustrated example, the input 118 and output 120 devices are depicted as separate components, but these components can be integrated together to form a single input/output (I/O) device, such as a touchscreen.

The accelerometer 122 tracks the acceleration and direction of the vehicle along three axes. Based on the acceleration and direction of the vehicle, the direction and/or movement of the light shown from the dynamic light pods 106 can be adjusted accordingly. The accelerometer 122 also captures information regarding the position of the vehicle's body with regard to level. In one form, the accelerometer 122 is contained within the control unit 102, but in other examples, the accelerometer 122 can be positioned elsewhere in the vehicle. In one example, the accelerometer includes a circuit board mounted microchip, which is commonly referred to as a solid state Gyro or MEMS device. The solid state Gyro or MEMS device includes an embedded three-axis gyroscope and/or a three-axis accelerometer. This sensor outputs a varying voltage proportional to its position in relation to gravity. This voltage is used to track the pitch and acceleration of the vehicle. As will be explained in greater detail below, the acceleration detected by the accelerometer 122 can also be used to determine if the vehicle rapidly stops so as to prevent unnecessary or errant movement of the light beams shown from the dynamic light pods 106. As almost everyone has experienced when inside a car or other vehicle, when it rapidly stops (or hits a bump), the front end of the vehicle tends to move rapidly downwards and springs back up again. The control unit 102 via the accelerometer 122 can detect such circumstances as well as others and takes appropriate corrective action such that the dynamic light pods 106 remain uninfluenced by the rapid change in acceleration.

FIG. 2 illustrates one particular application of the system 100 with the control unit 102. In this illustrated example, the mobile device 116 includes a head position tracking device 202 for tracking the head position of the vehicle's driver, operator, and/or other individuals. By monitoring the position and/or acceleration of the individual's head, the control unit 102 is able to direct or aim the lights from the dynamic light pods 106. As can be seen, the control unit 102 includes a controller circuit card assembly 204 that is operatively connected to a user interface 206. The controller circuit card assembly 204 includes a transceiver 114 in the form of a wireless receiver/transmitter (or transceiver) 208, and an accelerometer 122 in the form of a solid-state three-axis gyroscope and three-axis accelerometer 210. The wireless transceiver 208 is configured to communicate with the head position tracking device 202 via the BLUETOOTH® protocol. The three axis accelerometer/gyroscope 210 is configured to measure the acceleration and direction of the vehicle in three axes. The controller circuit card assembly 204 further includes a vehicle communication bus interface (or CAN data bus receiver/transmitter) 212 that is configured to communicate with the vehicle communication bus 112.

As depicted, a processor 214 is contained within a control unit 102. The processor 214 can include a microcontroller, DSP or any other type of processor known to those of ordinary skill in the art. The processor 214 performs a number of processing and functional operations for the control unit 102. Generally speaking, the processor 214 processes the data received from the other components and provides instructions for controlling the dynamic light pods 106 as well as other components of the system 100. The accelerometer 210 is in communication with the processor 214. This communication may be accomplished via a direct electronic link between the accelerometer 210 and the processor 214 as with a wire and/or a cable. This communication may also be accomplished via an electromagnetic link as with RF and/or BLUETOOTH® communication. The processor 214 receives the signals generated by the directional sensor 104, the accelerometer 210, and the speed sensor 110. In one example, a single processor 214 receives the signals generated by the directional sensor 104, the accelerometer 210, and the speed sensor 110. The processor 214 processes these signals via an algorithm in a process that generates a positional signal. In one form, this positional signal includes three components: a horizontal, a vertical, and a speed component. The horizontal direction of the light is directly proportional to the steering direction (i.e., as the steering wheel is turned to the left, the light will point more left). The direction of the light for the pitch of the vehicle is indirectly proportional to the attitude of the vehicle (i.e., as the vehicle nose is pointed more downward, the light will point more upward).

As depicted, the control unit 102 further includes a power supply 216 that supplies and conditions power from the power source 108 and an input/output (I/O) connector 218 to which a wiring harness is connected for communicating with and providing power to other components within the system 100. Right 220, level 222, and left 224 calibration buttons are used to calibrate the relative location of the steering wheel and position of the vehicle. The right calibration button 220 is used when the steering wheel is turned fully right such that the wheels (or other motive mechanisms) can no longer turn further to the right. Pressing the level calibration button 222 indicates that the vehicle is positioned on level ground, and pressing the left calibration button 224 indicates when the steering wheel has turned the wheels of the vehicle in the farthest left direction.

As can be seen, the user interface 206 includes a number of input 118 and output 120 devices. The input devices 118 include a joystick 226, a power switch 228, and a steering sensitivity switch 230. Among its many functions, the joystick 226 can be used to manually position the directions of the light shone from the dynamic light pods 106. In other words, the joystick 226 provides manual pitch and yaw control of the dynamic light pods 106. The joystick 226 in one form includes a two axis joystick with a momentary pushbutton. In one example, the pushbutton of the joystick 226 can be held for 2 seconds in order to toggle between automatic and manual control modes. While in the manual mode, the direction of the lights can be locked in a location by quickly tapping the button on the joystick 226. Release of the lock can occur by tapping the button on the joystick 226 again. In another example, the control unit 102 includes a separate switch that overrides the signal from the processor 214 and allows the dynamic light pods 106 to be operated manually via the joystick 226 or other control.

The power switch 228 is used to turn on and off the control unit 102 along with the rest of the system 100. The steering sensitivity switch 230 adjusts the responsiveness of the dynamic lights to the steering movement sensed by the directional sensor 104. For example, the lights move quicker and/or to a greater extent during turning when in high sensitivity mode as compared to the low sensitivity mode. The output devices 120 include a power indicator light 232, an auto/manual indicator light 234, and a calibration accepted indicator light 236. In the illustrated example, the lights 232, 234, 236 are in the form of LEDs, but in other examples, the lights can come in other forms (e.g., incandescent lights, OLEDs, etc.). The power indicator light 232 indicates when the control unit 102 is powered. The auto/manual indicator light 234 indicates when the control unit 102 is in a manual or automatic operational mode. For instance, when in the manual mode, the operator via the joystick 226 is able to manually move the direction of light shone from the dynamic light pods 106. In the automatic mode, the control unit 102 automatically or semi-automatically adjusts the direction of the light emitted by the dynamic light pods 106. The calibration accepted indicator 236 indicates whether the control unit 102 has been properly calibrated.

The head position tracking device 202 provides another way for an individual to manually interface with the control unit 102. In one example, the direction of the lights shown by the dynamic light pods 106 is controlled based on the relative head position of the operator detected by the head position tracking device 202. In other words, the lights from the dynamic lights generally track where the individual is looking. This can be useful when the driver or passenger is out of the cab of the vehicle and wants to look at particular location at night or in other low light conditions. As depicted, the head position tracking device 202 includes first 238 and second 240 accelerometer/gyroscope devices that are used to track the direction and movement (acceleration) of the individual wearing the head position tracking device 202. In the illustrated example, the accelerometer/gyroscope devices 230, 240 each include a solid-state three-axis accelerometer and a three-axis gyroscope, but other types of accelerometers and gyroscopes can be used in other examples. A wireless transceiver 242 is configured to receive and transmit information to and from the head position tracking device 202. In the depicted example, the wireless transceiver 242 includes a BLUETOOTH® type transceiver. A processor 244 controls the operation of the head position tracking device 202, and a power supply 246 provides power to the head position tracking device 202. In one form, the power supply 246 includes rechargeable batteries, but in other examples, the head position tracking device 202 can be powered in other manners.

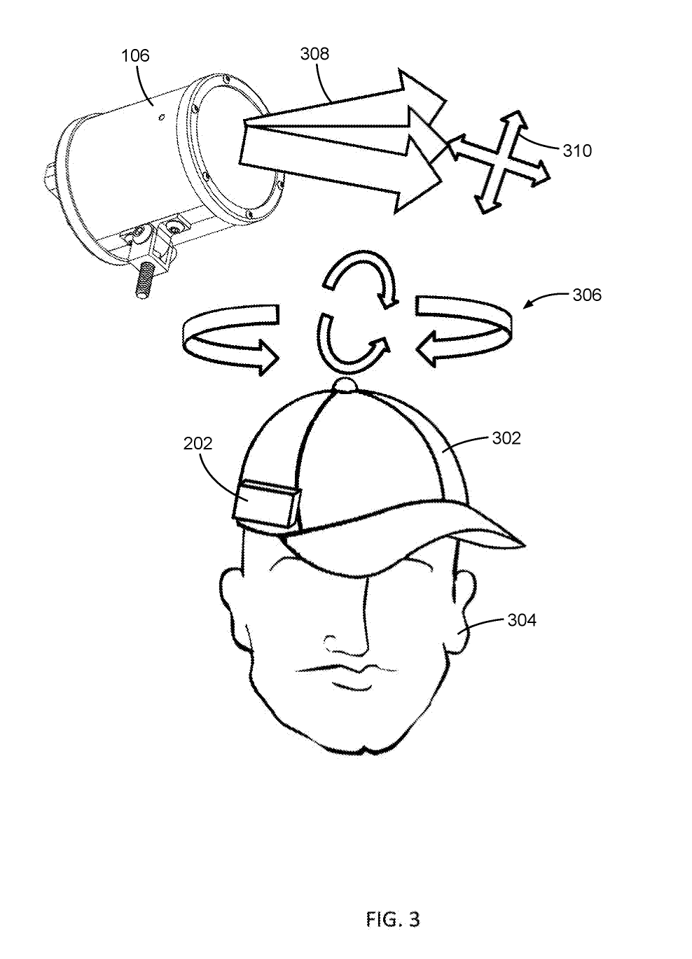

FIG. 3 illustrates an example of how the head position tracking device 202 is used to change the direction of the light shone from the dynamic light pods 106. As shown, the head position tracking device 202 is attached to a hat 302 worn on the head of an individual 304. In other examples, the head position tracking device 202 can be attached to the head via a headband, helmet, visor, earpiece, and/or in other manners. In still yet another variation, a cell phone or other mobile device 116 is used instead of the head position tracking device 202. For instance, the direction and movement of the light beams from the dynamic light pods 106 is controlled based on the position, movement, and orientation of the cell phone as provided by the accelerometer/gyroscope (and/or GPS device) in the cell phone. In one example, the head position tracking device 202 communicates the head position and movement of the individual 304 via BLUETOOTH® protocol to the control unit 102 through the wireless transceiver 242. In FIG. 3, movement of the head of the individual 304 is indicated by head movement arrows 306. When the head of the individual 304 moves, as indicated by arrows 306, the control unit 102 instructs one or more of the dynamic light pods 106 to change the direction of light 308 shown from the dynamic light pods 106 as is depicted by direction arrows 310.

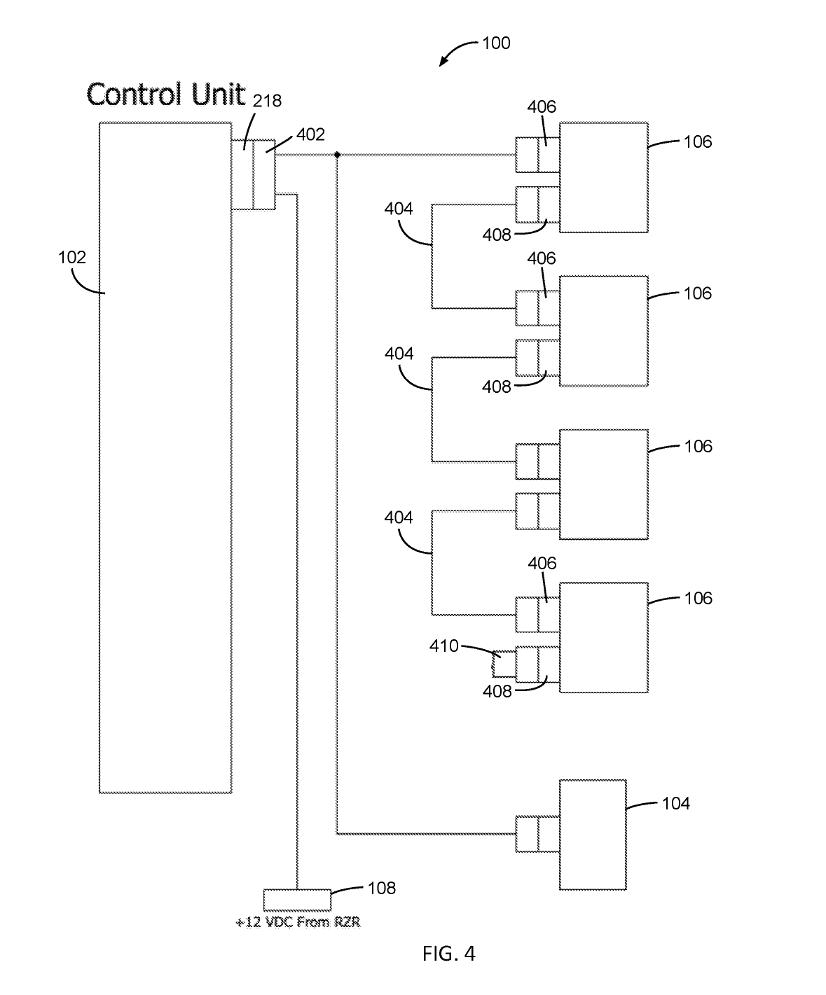

Turning to FIG. 4, various wiring harnesses are shown for connecting the control unit 102, the directional sensor 104, the dynamic light pods 106, and the power source 108 to one another. As can be seen, a main harness 402 connects the directional sensor 104, the dynamic light pods 106, and the power source 108 to the I/O connector 218 of the control unit 102. A pod harness 404 connects the dynamic light pods 106 together. Each of the dynamic light pods 106 have an input connector 406 and an output connector 408. The first one of the dynamic light pods 106 is connected to the main harness 402, and subsequent (e.g., second, third, etc.) dynamic light pods 106 are connected together via the pod harnesses 404. In one example, one of the pod harnesses 404 can be used to connect the first dynamic light pods 106 to the main harness 402 so as to provide additional length for the connection. As can be seen, the output connector 408 for the upstream dynamic light pods 106 is connected to the input connector 406 of the subsequent, downstream dynamic light pods 106. This daisy chain created by the pod harnesses 404 is terminated by a CAN bus termination 410 at the last output connector 408. It should be appreciated that this configuration helps to simplify installation because only one of the dynamic light pods 106 needs to be connected directly to the control unit 102 in order for the system 100 to operate. This eliminates unnecessary wiring, which simplifies installation as well as enhances the durability of the system 100. Moreover, this configuration provides greater flexibility such that dynamic light pods 106 can be easily added, moved, removed, and/or swapped, depending on the specific needs at that point in time.

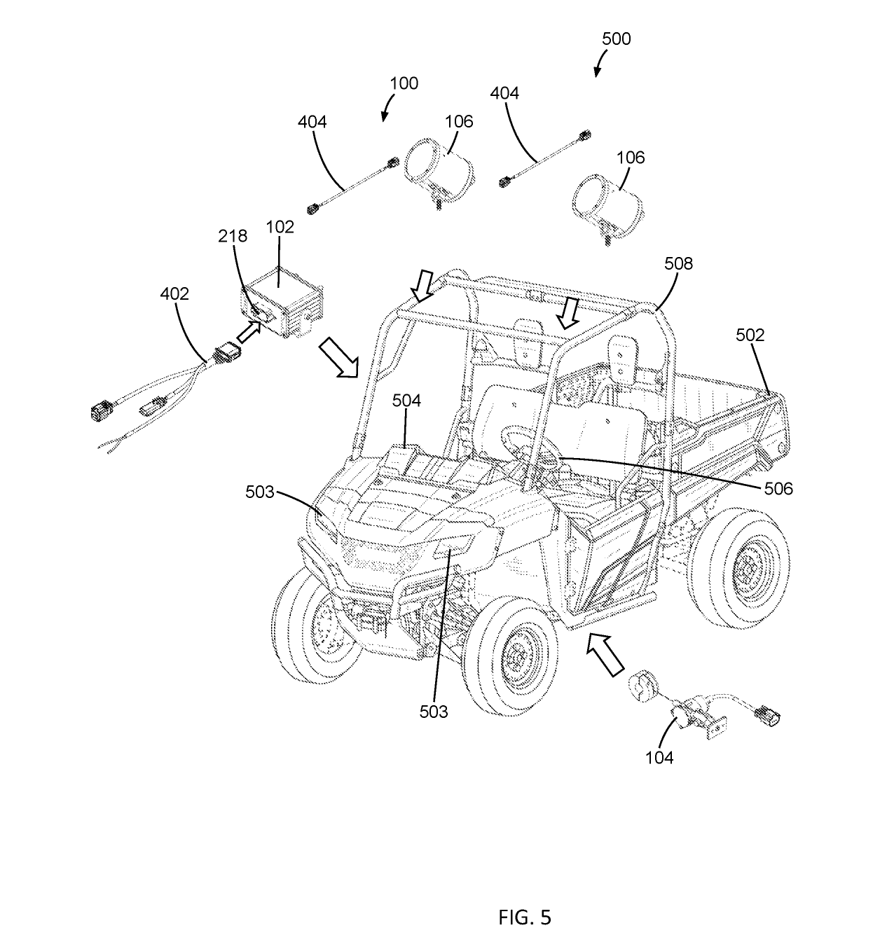

FIG. 5 shows an exploded view of the system 100 as incorporated into a vehicular system 500. As depicted, the vehicular system 500 includes a vehicle 502 to which the components of the dynamic light control system 100 are attached. In the illustrated example, the vehicle 502 includes an All-Terrain Vehicle (ATV), but it should be recognized that in other examples the system 100 can be incorporated into other types of vehicles, such as trucks, motorcycles, cars, boats, and/or personal watercraft, to name just a few. As can be seen, the vehicle 502 already includes one or more pre-existing headlights 503 that were incorporated in into the vehicle 502 when the vehicle 502 was originally manufactured. The system 100 is designed to be installed in the aftermarket, that is, after the vehicle 502 is initially sold. A number of features of the system 100 facilitate installation or retrofitting to pre-existing vehicles 502. The control unit 102 is a separate component from the vehicle 502 such that the control unit operates autonomously from the rest of the vehicle 502. The control unit 102 in the depicted example is mounted inside or to a dashboard 504 of the vehicle 502, but the control unit 102 can be mounted elsewhere. The directional sensor 104 is configured to be readily retrofitted to the vehicle 502. As indicated in FIG. 5, the directional sensor 104 is mounted inside the chassis of the vehicle 502 and coupled to the shaft of a steering apparatus or wheel 506 for the vehicle 502. As noted before, the dynamic light pods 106 are separate from the originally installed lights 503 of the vehicle 502. In one example, the dynamic light pods 106 are mounted to a roll frame 508 of the vehicle 502, but in other examples, the dynamic light pods 106 can be mounted elsewhere on the vehicle 502. Likewise, the other components of the system 100 can be mounted elsewhere within or on the vehicle 502. As can be seen, the components of the system 100 are operatively connected together via the main harness 402 and the pod harnesses 404.

FIGS. 6, 7, 8, and 9 show respectively front perspective, rear perspective, front, and exploded views of the control unit 102 according to one example. Of course, the control unit 102 can be configured differently than is shown in other examples. As can be seen, the control unit 102 includes a housing 602 and a mounting bracket 604 coupled to the housing 602 for mounting the control unit 102 to the dashboard 504 of the vehicle 502. The mounting bracket 604 includes mounting bolts 606 that are fastened to the housing 602. The mounting bolts 606 allow the angular orientation of the control unit 102 to be changed and fixed in place. In the illustrated example, the user interface 206 and the I/O connector 218 are mounted on opposite sides of the control unit 102, but in other examples, these components can be mounted elsewhere.

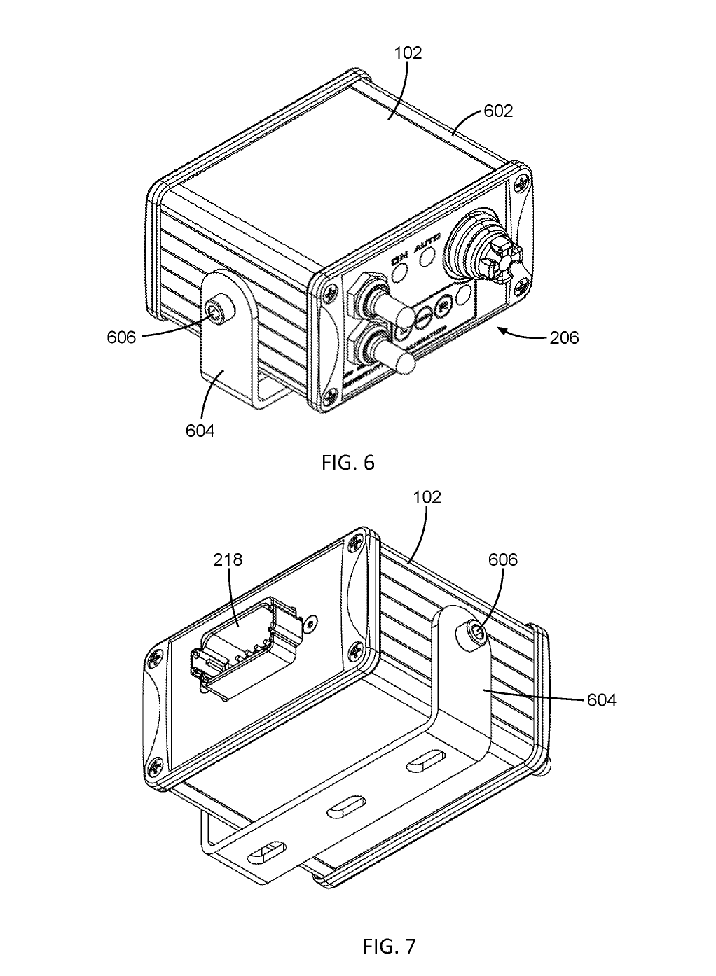

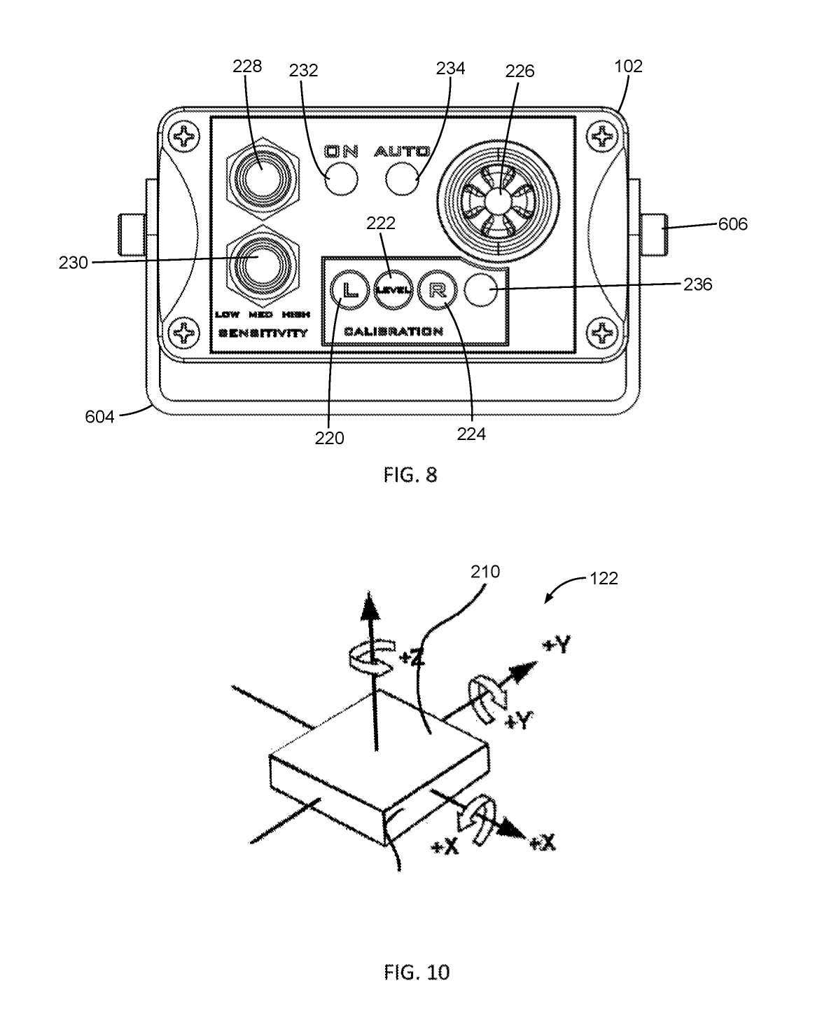

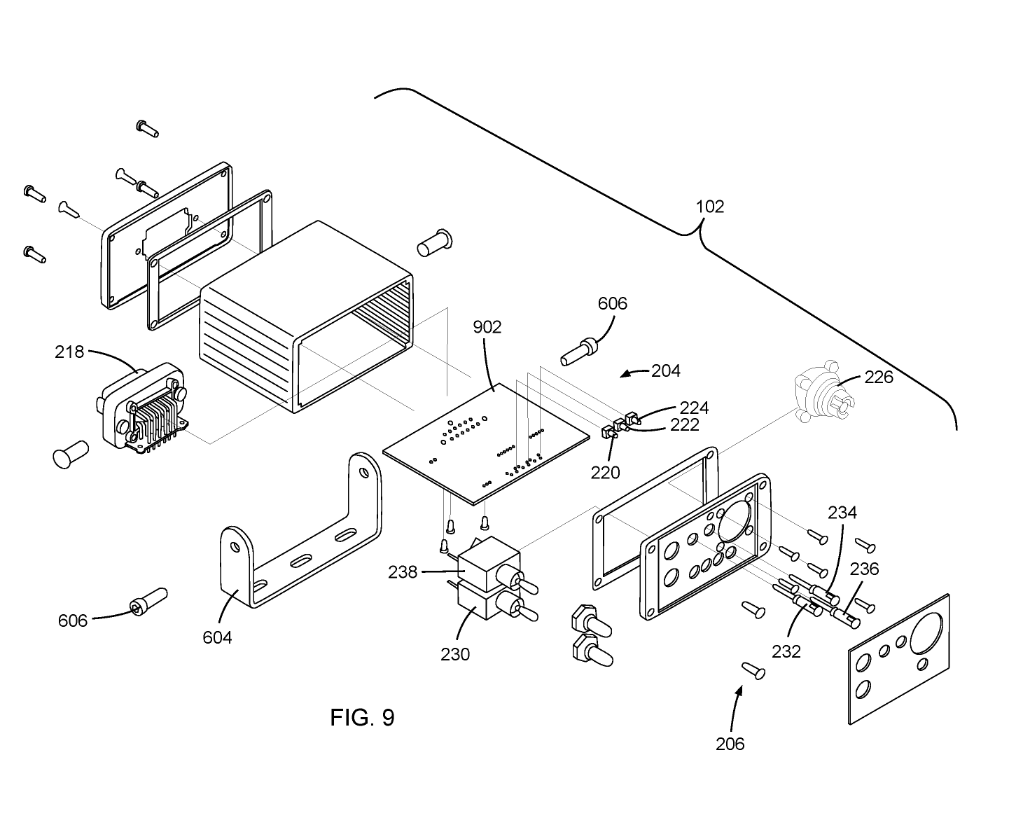

Turning to FIGS. 8 and 9, the user interface 206 includes the calibration buttons (220, 222, 224), joystick 226, power switch 228, and steering sensitivity switch 230 of the type described before. Likewise, the user interface 206 has the power indicator light 232, automatic/manual light 234, and the calibration acceptance indicator light 236 of the type as previously described. These components are connected to the controller circuit card assembly 204. In the illustrated example, the card assembly 204 includes a circuit board 902 upon which the selected components of the control unit 102 are mounted, such as the wireless transceiver 114 (208), accelerometer/gyroscope 122 (210), bus interface 212, processor 214, and power supply 216 (FIG. 2). FIG. 10 shows a perspective view of the three-axis accelerometer/gyroscope 210 that is mounted on the circuit board 902. As shown, the accelerometer/gyroscope 210 is able to track acceleration and/or direction along three axes (e.g., x, y, and z axes).

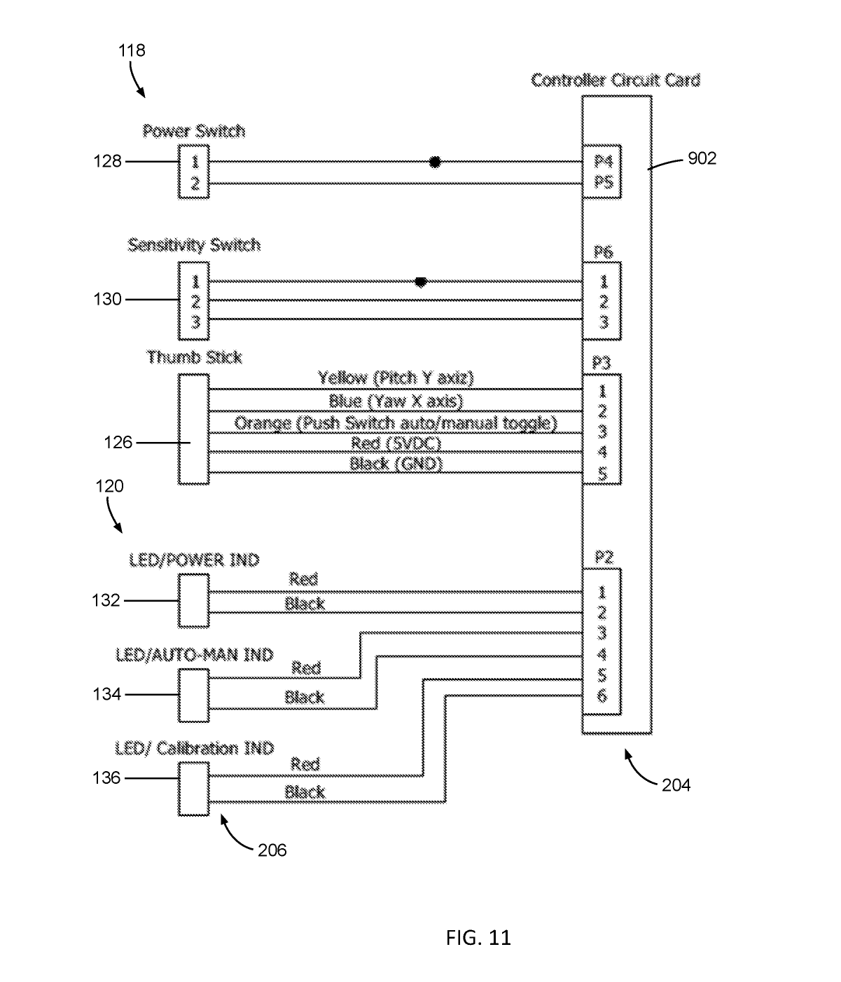

FIG. 11 shows a schematic of how the input devices 118 and output devices 120 are connected to the circuit board 902 of the controller circuit card assembly 204. In the illustrated example, the input devices 118 include the joystick (or thumb stick) 226, power switch 228, and steering sensitivity switch 230. The output devices 120 in the depicted example include the power 232, automatic/manual 234, and calibration accepted 236 indicator lights.

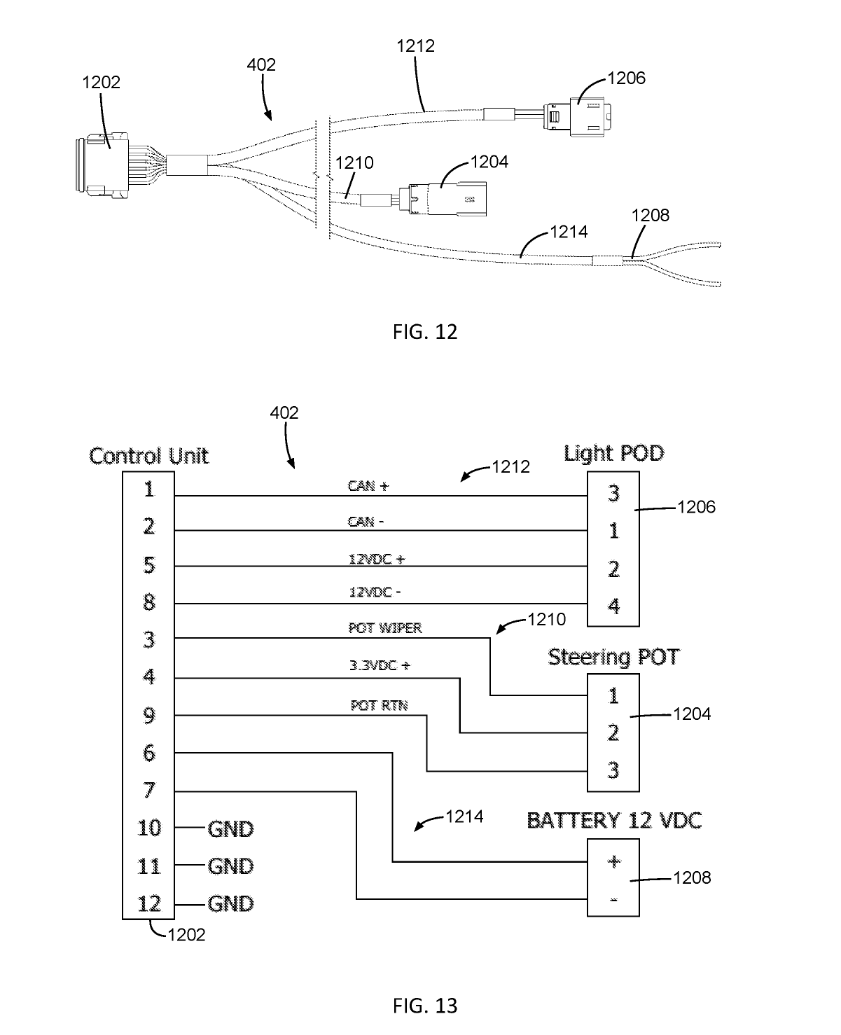

As noted before, the main harness 402 connects the control unit 102 to the directional sensor 104, the dynamic light pods 106, and the power source 108. Top and schematic views of the main harness 402 are shown in FIGS. 12 and 13, respectively. As depicted, the main harness 402 includes a control unit connector 1202 that is configured to connect to the I/O connector 218 on the control unit 102. A directional sensor connector 1204 of the main harness 402 is designed to connect to the directional sensor 104. In the illustrated example, the main harness 402 has a dynamic light pod connector 1206 configured to connect to one of the dynamic light pods 106 and/or the pod harness 404. Further, the main harness 402 includes a power source connector 1208 configured to connect to the power source 108, such as the battery of the vehicle 502. Sensor 1210, light pod 1212, and power 1214 cables respectively connect the directional 1204, light pod 1206, and power 1208 connectors to the control unit connector 1202.

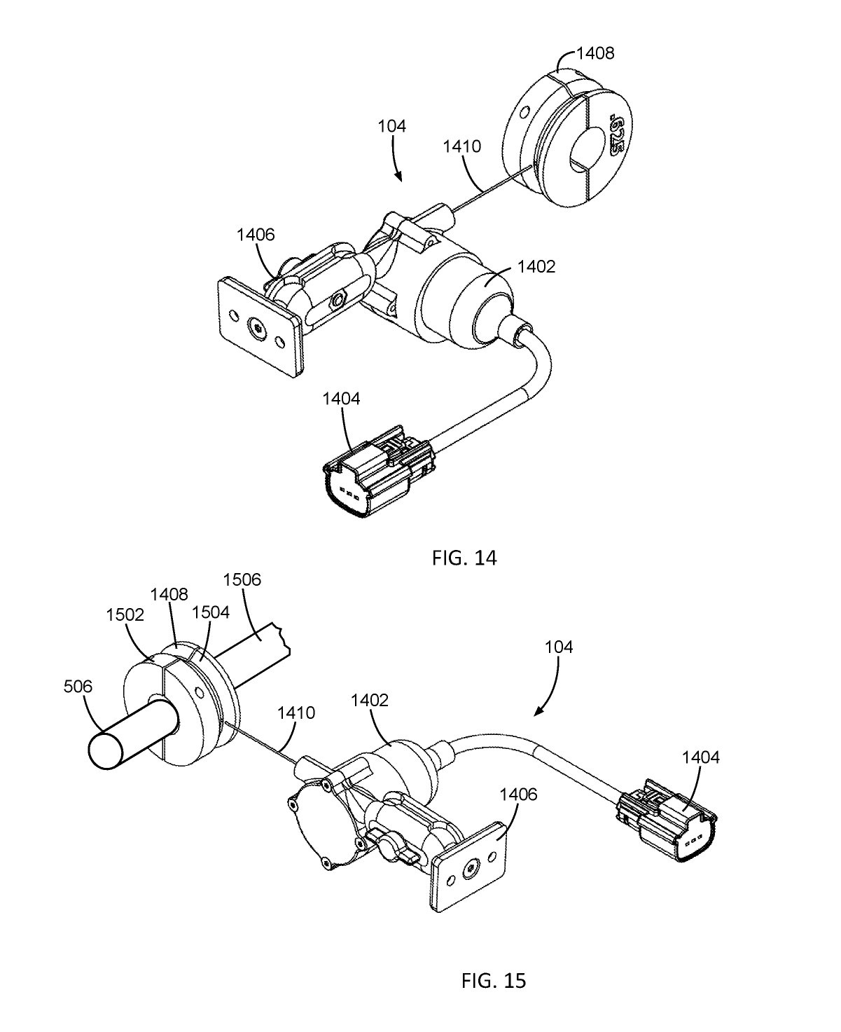

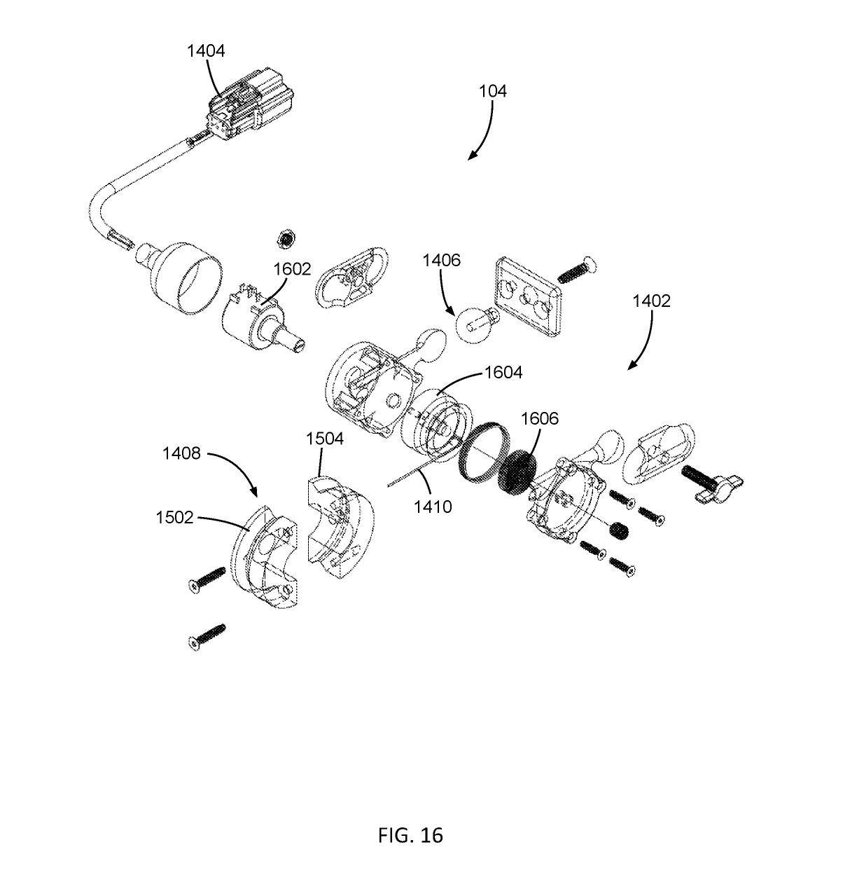

Again, the directional sensor 104 in one example is configured to detect the direction of the vehicle 502 by monitoring the angular position of the steering apparatus 506. FIGS. 14, 15, and 16 respectively depict front perspective, rear perspective, and exploded views of one version of the directional sensor 104. In the illustrated example, the degree of rotation of the steering apparatus 506 from a position that would correspond to normal is measured using a cable-extension transducer 1402. The cable-extension transducer 1402 is sometimes also known as a string pot, a draw wire sensor, or a string encoder. As shown, the directional sensor 104 includes a harness connector 1404 configured to couple to the directional sensor connector 1204, a mounting bracket 1406 for mounting the directional sensor 104 to the vehicle 502, a steering coupler or pulley 1408, and a cable 1410 extending between the cable-extension transducer 1402 and the steering coupler 1408. The harness connector 1404 provides an electrical connection from the directional sensor 104 to the control unit 102 via the main harness 402. The mounting bracket 1406 in the illustrated example is an orbital type mounting bracket that allows the location of the cable-extension transducer 1402 to be pivotally adjusted and locked into place. This ensures that the cable-extension transducer 1402 is properly positioned relative to the steering coupler 1408 such that the cable 1410 is able to extend and retract smoothly. As depicted in FIGS. 15 and 16, the coupler 1408 includes two sections 1502, 1504 that are configured to clamp to a shaft 1506 of the steering apparatus 506. Together the sections 1502, 1504 form a generally cylindrical shape around which the cable 1410 is wrapped.

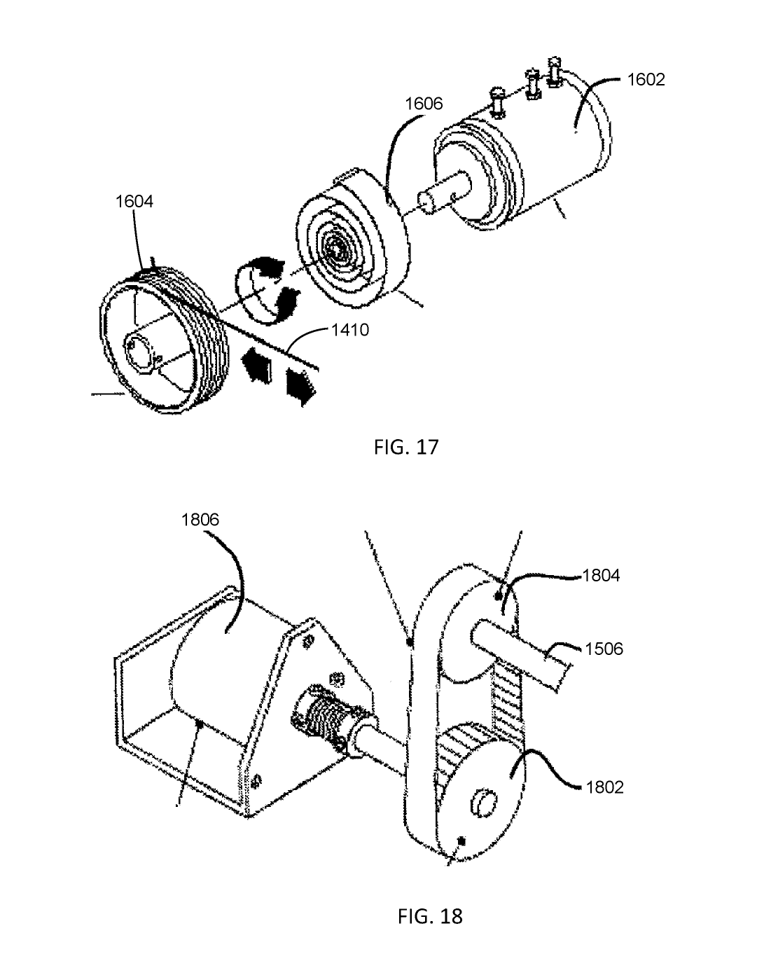

Looking at the exploded view shown in FIG. 16, the cable-extension transducer 1402 includes a potentiometer 1602 that is electrically connected to the harness connector 1404. The cable 1410 is wrapped around a spring-loaded spool 1604 attached to a spring 1606, and the potentiometer 1602 is likewise attached to the spring 1606. The cable-extension transducer 1402 detects and measures linear position and velocity using the pulley 1408, the cable 1410, and the spring-loaded spool 1604. As mentioned before, the pulley 1408 is attached to the steering shaft 1506 of the vehicle 502. Referring to FIGS. 16 and 17, when the shaft 1506 turns, the pulley 1408 also turns. As the pulley 1408 turns, the cable 1410 exerts a force on the spring-loaded spool 1604 that is directly proportional to the degree to which the steering shaft 1506 has been turned from the normal direction. The force on the spring 1606 from the spool 1604 is translated by the attached potentiometer 1602 into a voltage that is directly proportional to the force exerted on the spool 1604. This voltage is used by the system 100 to track steering angle. In particular, the voltage signal is transmitted to the control unit 102, and the control unit 102 interprets the voltage signal to determine the steering angle of the vehicle 502. Based on the determined steering angle, the control unit 102 adjusts the lighting angle from the dynamic light pods 106.

In another example depicted in FIG. 18, the steering angle position is sensed by way of a first pulley 1802 and a second pulley 1804. The first pulley 1802 is attached to a rotary potentiometer or rotary encoder 1806. The second pulley 1804 is attached to the steering shaft 1506. In another embodiment, the steering angle position is sensed by intercepting/capturing the steering angle position data from the factory computer, typically known as OBDii or CAN communication bus 112, installed in the vehicle 502 in which the system 100 is installed.

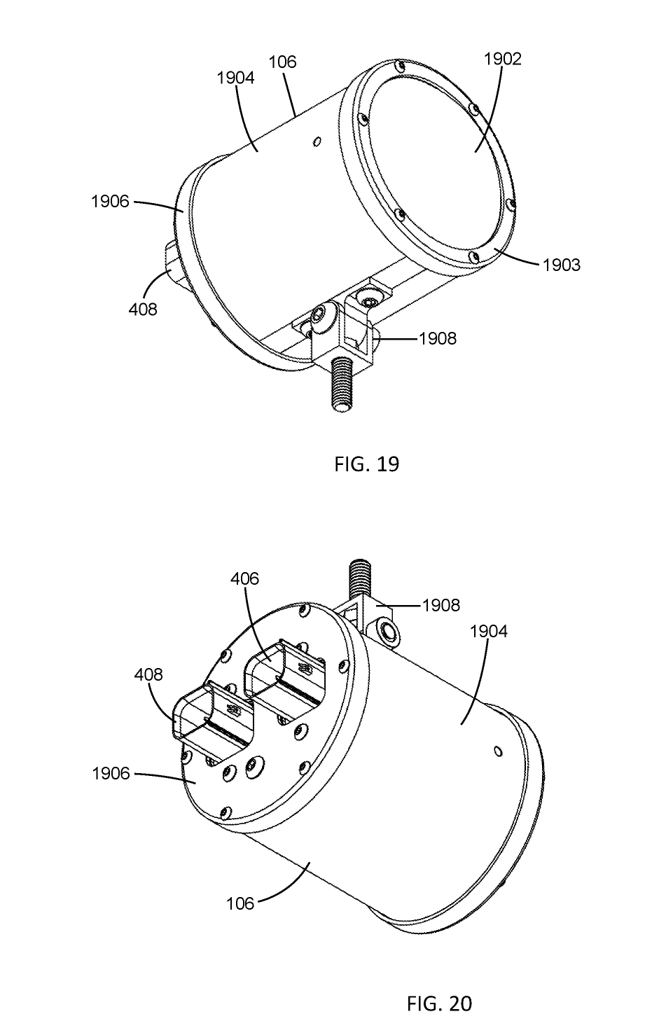

As noted before, the dynamic light pod 106 is configured to move the direction of the beam of light shone while the exterior of the dynamic light pod 106 remains stationary. The dynamic light pod 106 in the illustrated example is designed to be easily retrofitted to existing vehicles 502 while at the same time the dynamic light pod 106 is sturdy and water resistant. FIGS. 19, 20, and 21 respectively show front perspective, rear perspective, and exploded views of the dynamic light pod 106. As shown, the dynamic light pod 106 includes a lens cover 1902 with a bezel 1903 that is secured to a housing 1904. The lens cover 1902 and bezel 1903 are designed to seal the housing 1904, and at the same time, allow light to shine through. Opposite the lens cover 1902, a connector cover 1906 is secured to the housing 1904. As illustrated, the input 406 and output 408 connectors extend from the connector cover 1906. The connector cover 1906 seals the housing 1904 so as to minimize dirt and water infiltration. A mounting bracket 1908 is pivotally secured to the housing 1904. The mounting bracket 1908 is designed to adjust the angle of the dynamic light pod 106 as well as secure the dynamic light pod 106 to the vehicle 502.

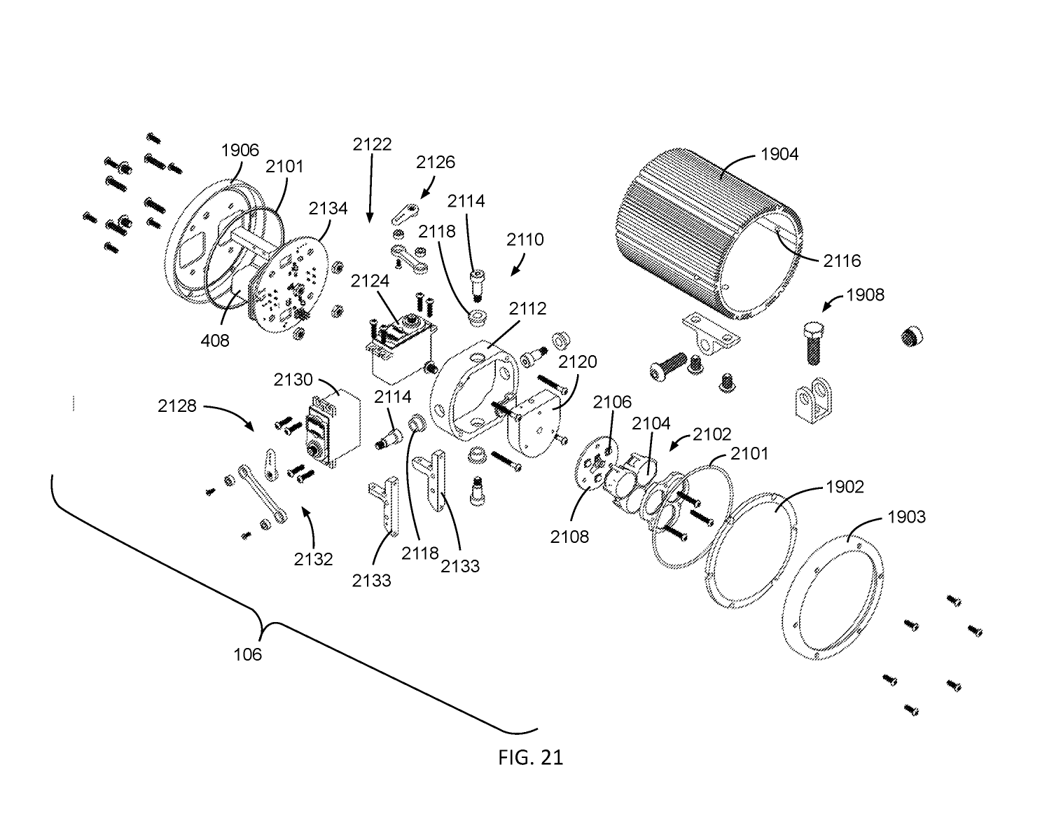

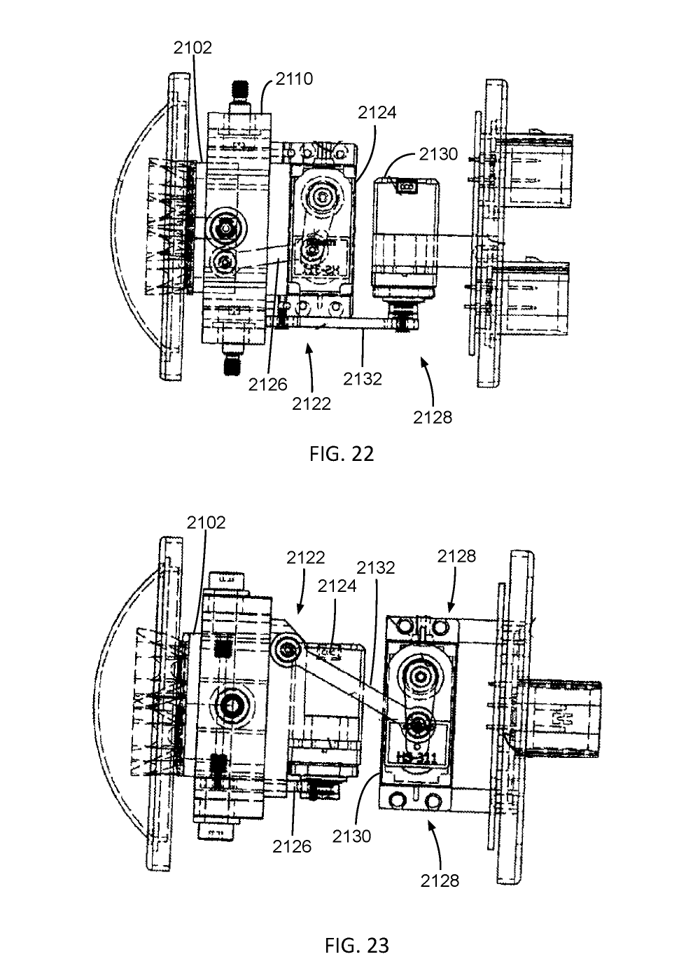

Referring to FIGS. 21, 22, and 23, one or more seals 2101 at the lens cover 1902 and connector cover 1906 seal both ends of the dynamic light pod 106 against water and debris infiltration. The dynamic light pod 106 includes at least one illumination or light element 2102 pivotally mounted in the housing 1904. The illumination element 2102 can include incandescent, halogen and/or LED light sources, to name just a few examples. As shown, a reflector lens 2104 covers one or more light sources 2106 mounted to a light source support or board 2108. In the illustrated example, the light sources 2106 are in the form of three LEDs, but it should be recognized more or less light sources 2106 can be used and/or different types of light sources can be used.

The illumination element 2102 is mounted to a pivot support or gimbal 2110 that facilitates pivotal movement of the illumination element 2102. As shown, a support frame 2112 is pivotally connected to the housing 1904 via one or more pivot bolts 2114 that are threadably secured in threaded pivot openings 2116 in the housing 1904. Bushings 2118 promote pivotal movement of the support frame 2112. As can be seen, the illumination element 2102 is mounted to a pivot base 2120 that is pivotally mounted to the support frame 2112 via the pivot bolts 2114 and bushings 2118. A horizontal or yaw actuator 2122 is connected to the gimbal 2110 so as to promote horizontal pivotal or yaw movement of the illumination element 2102. As depicted, the yaw actuator 2122 includes a motor 2124 with linkages 2126 connected to the gimbal 2110 to promote the yaw movement of the illumination element 2102. A vertical or pitch actuator 2128 is connected to the gimbal 2110 so as to promote vertical pivotal or pitch movement of the illumination element 2102. The pitch actuator 2128 includes a motor 2130 with linkages 2126 connected to the gimbal 2110 to promote pitch movement of the illumination element 2102. In the illustrated example, linkages 2126 and 2132 are lengthened to promote greater degrees of movement. As shown, mounting brackets 2133 are used to secure the yaw actuator 2122 and the pitch actuator 2128.

A wide variety of movements can be achieved by actuating the yaw actuator 2122 and/or the pitch actuator 2128. The motors 2124, 2130 of the actuators 2122, 2128 are operatively connected to a circuit board 2134 via an electrical connection. In one example, the circuit board 2134 includes a processor that controls the operation of the motors based on the signals received from the control unit 102. In one particular example, the circuit board 2134 includes a processor for each motor 2124, 2130 (i.e., a horizontal processor and a vertical processor). In this example, the speed component of the positional signal is received by the horizontal processor and the vertical processor. The vertical processor and the horizontal processor convert this signal into a level of current used to drive the vertical 2124 and horizontal 2130 motors sufficient to operate the motors at a speed necessary to cause the pivotable base 2120 to move at the speed determined by the processor.

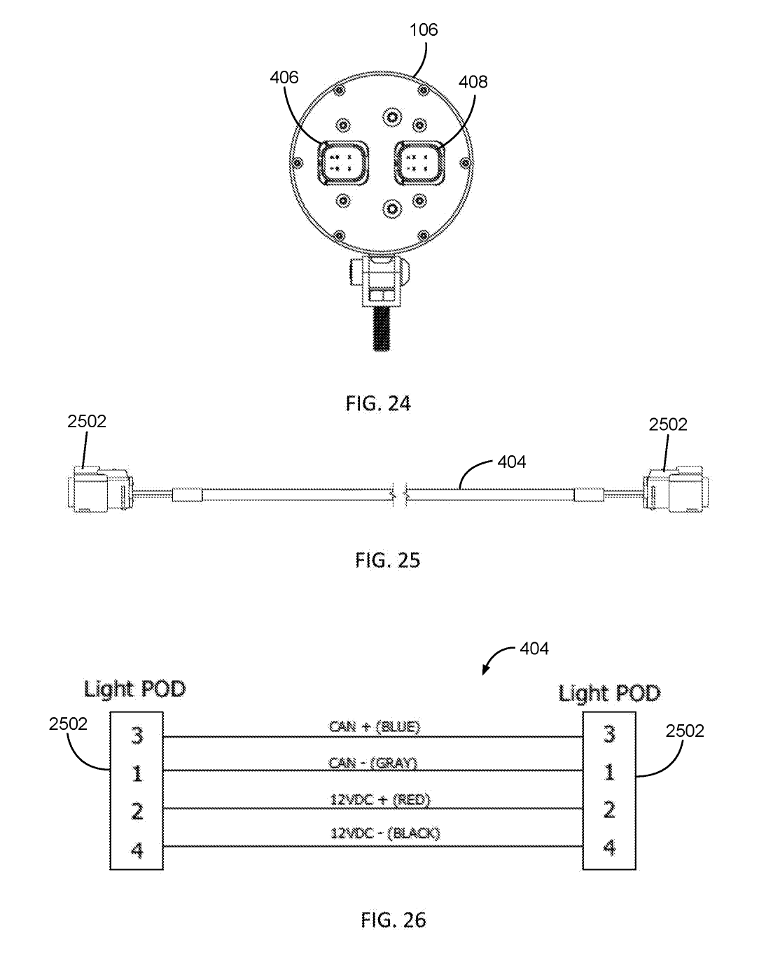

Looking at FIGS. 20, 21, and 24, the circuit board 2134 has the connectors 406, 408 that are directly or indirectly connected to the control unit 102 via the harnesses 402, 404. FIGS. 25 and 26 respectively provide top and diagrammatic views of the pod harness 404 that is connected to the connectors 406, 408. As shown, the pod harness 404 at each end has a connector 2502 configured to connect to the connectors 406, 408 of the dynamic light pods 106 and/or the main harness 402.

With the harnesses 402, 404, the control unit 102 via the circuit board 2134 controls the actuators 2122, 2128. Again, the yaw actuator 2122 causes side to side (e.g., left-right) pivotal motion of the light shone from the illumination element 2102, and the pitch actuator 2128 causes up-and-down pivotal motion of the light shone from the illumination element 2102. The control unit 102 sends horizontal and/or vertical positional signals to the dynamic light pod 106 to cause this movement. The horizontal component of the positional signal is received by the horizontal motion or yaw actuator 2122. The circuit board 2134 receives a signal from the control unit 102 to pivot the illumination element 2102 a certain number of degrees to the left or right. This signal is converted to cause the motor 2124 to turn a certain number of revolutions either clockwise or counter clockwise. The number of revolutions and direction correspond to the number of degrees left or right the illumination element 2102 needs to turn based on the signal received from the control unit 2102. The dynamic light pod 106 via the circuit board 2134 is also configured to receive a signal from the processor to rotate the illumination element 2102 a certain number of degrees up or down. When such a signal is received, the motor 2130 for the pitch actuator 2128 rotates a certain number of revolutions either clockwise or counter clockwise. The number of revolutions and direction correspond to the number of degrees up or down the illumination element 2102 needs to turn based on the signal received from the control unit 102. During these movements of the illumination element 2102, the housing 1904 of the dynamic light pod 106 remains generally stationary.

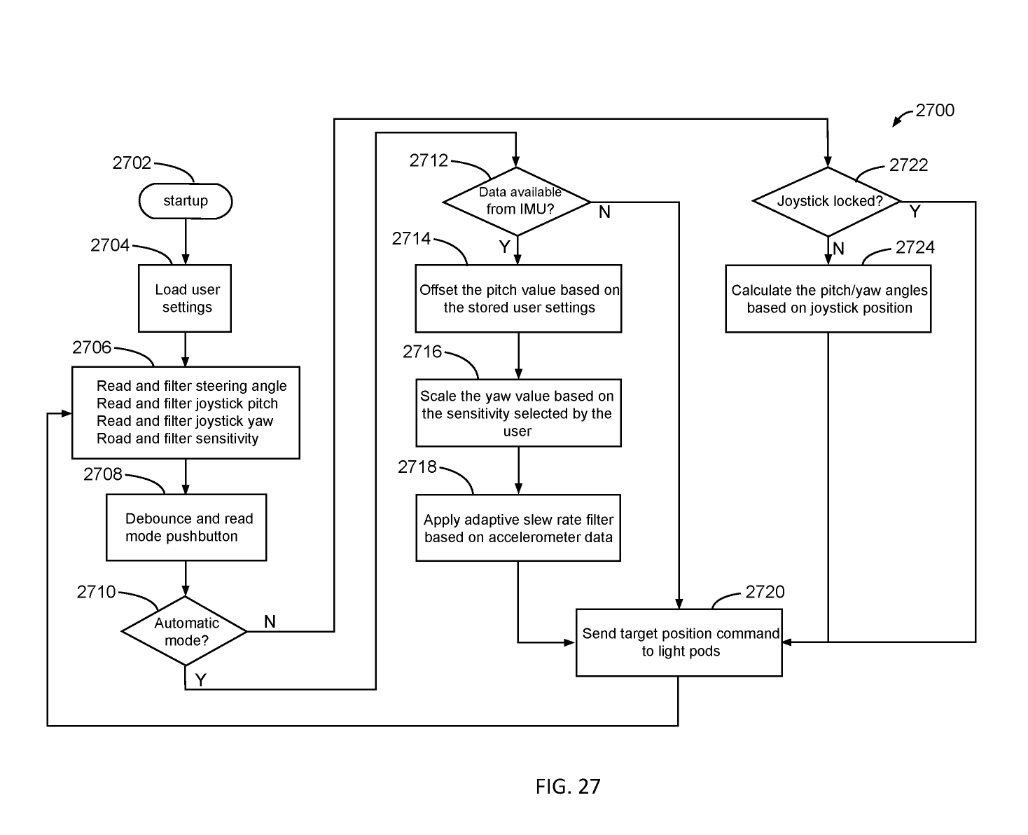

FIG. 27 includes a flow diagram 2700 that illustrates the various acts or stages for the active or dynamic light control system 100 during operation. As should be recognized, most of the steps are performed by the processor 214 of the control unit 102, but it should be appreciated that some of these acts can be performed by other components in the system 100. Upon starting up in stage 2702, the control unit 102 loads the specific user settings in stage 2704. For example, the user settings can include calibration settings for the system 100. Usually, but not always, the components of the system 100, such as the accelerometer 122 and dynamic light pods 106, can have variations from piece to piece. The calibration settings are used to compensate for these differences. In stage 2706, the processor 214 (FIG. 2) of the control unit 102 reads the specific steering angle sensed by the directional sensor 104. The steering angle sensed in stage 2706 can be filtered to reduce or eliminate extraneous readings. The relative location (i.e., pitch and yaw) of the joystick 226 is also read and filtered in stage 2706 along with the steering sensitivity as selected by the steering sensitivity switch 230. As mentioned before with respect to FIG. 2, the joystick 226 further includes a pushbutton feature that is used to select whether or not the dynamic light pods 106 are automatically or manually controlled. In stage 2708, the pushbutton in the joystick 226 is the debounced and read to determine the mode. In one example, the automatic/manual indicator light 234 is lit or unlit depending on the mode selected. Based on the pushbutton state of the joystick 226, the processor 214 of the control unit 102 in stage 2710 determines whether an automatic mode or a manual mode was selected.

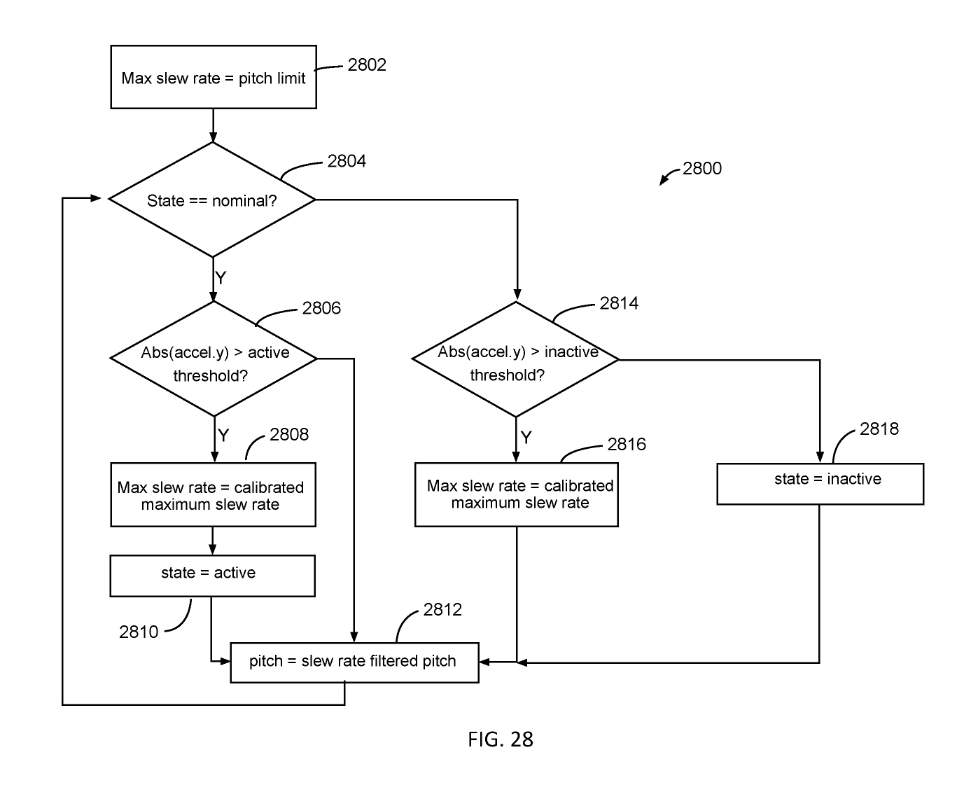

When the automatic mode is selected, the control unit 102 in stage 2712 determines whether any data is available from the accelerometer/gyroscope 122, 210 (e.g., an Inertial Measurement Unit or IMU for short). If there is data available from the accelerometer/gyroscope 122, the control unit 102 offsets the set pitch value based on the user settings in stage 2714. In one example, the calibration settings can be used to offset the automatically calculated pitch. In another example, the driver may prefer to have the lights normally angled downwards so as to improve the visibility of the terrain. The control unit 102 uses this desired pitch for the light shone from the dynamic light pods 106 as an initial point for subsequent adjustments to the pitch. In stage 2716, the initial yaw value is scaled by the control unit 102 based on the sensitivity selected by the user with the sensitivity switch 230. For example, when a high sensitivity level is selected, the scale selected will magnify or increase the rate at which the beams of light from the dynamic light pods 106 move horizontally (i.e., left-right) as a result of the steering angle detected by the directional sensor 104. In comparison, when a low sensitivity level is selected, the light beams shown from the light pods 106 move at a lesser rate in a horizontal direction in relation to the steering direction of the vehicle 502 as detected by the directional sensor 104. As will be discussed in greater detail below with respect to FIG. 28, the control unit 102 in stage 2718 applies an adaptive slew rate filter based on the accelerometer data received from the accelerometer 122 when determining to what extent to adjust the pitch (and yaw, if desired) of the light beams shown from the dynamic light pods 106. This adaptive slew rate filter helps to minimize or prevent sudden movement of the light beams during sudden jolts to the vehicle 502, such as during emergency stops, hitting potholes, extreme dips in the road, etc. When a rapid change in the acceleration or deceleration of the vehicle 502 is detected by the accelerometer 122, the control unit 102 reduces the rate at which the pitch and/or yaw of the light beams is changed. The processor 214 of the control unit 102 calculates the target pitch and/or yaw orientations, and the control unit 102 via the main 402 and/or pod 404 harnesses sends a signal to one or more of the dynamic light pods 106 providing the target position for the light beams shown from the dynamic light pods 106 in stage 2720. Based on the received target positions, the yaw (horizontal) 2122 and/or pitch (vertical) 2128 actuators rotate the illumination element 2102 to the desired orientation. It should be recognized that the pitch and/or yaw values calculated in stages 2714, 2716, and 2718 can also be adjusted based on the speed sensed from the speed sensor 110. For instance, when at high speeds, the pitch and yaw can be changed more rapidly as compared to when the vehicle is traveling at low speeds. Returning to stage 2712, when the acceleration and/or positioned data is not available from the accelerometer/gyroscope 122, the control unit 102 sends the target pitch and yaw positions for the lights without making any compensation for storage user settings, sensitivity selections, and/or accelerometer data for transmitting to the light pods 106 in stage 2720. In other words, nothing changes from the initial values or previously calculated values, and the previously determined target pitch and/or yaw signals are sent to the dynamic light pod 106. Upon setting the target pitch and/or yaw of the dynamic light pods 106 in stage 2720, the processor 214 returns or loops back to stage 2706 to start the process again.

Referring again to stage 2710 in FIG. 27, when the processor 214 of the control unit 102 determines that the system 100 is in a manual control mode, the control unit 102 proceeds to stage 2722. In stage 2722, the control unit 102 determines whether or not the joystick 226 is locked. If the joystick is locked, the control unit 102 sends the target position commands to the light pods 106 in stage 2720. On the other hand, when the joystick 226 is not locked, the control unit 102 in stage 2724 calculates the pitch and/or yaw angles based on the position of the joystick 226 and sends the target pitch and/or yaw angles to the dynamic light pods 106. In another variation, the joystick 226 is configured to control the direction and/or light intensity from individual light pods 106. For instance, the user can tap on the pushbutton in the joystick 226 to toggle through controlling the individual dynamic light pods 106 in series so as to individually control them. Once the signal for the target pitch and/or yaw of the dynamic light pods 106 is sent in stage 2720, the processor 214 returns or loops back to stage 2706 to start the process again.

As noted before with respect to stage 2718 in FIG. 27, the system 100 utilizes an adaptive slew rate filter to minimize rapid movement of the light beams during rapid acceleration or deceleration, such as due to emergency braking, rapid acceleration, hitting a bump, and the like. FIG. 28 shows a flowchart 2800 for one technique for creating such an adaptive slew rate filter. In this case, the slew rate refers to the rate of change of pitch movement of the light beams shown by the dynamic light pods 106. In other examples, slew rate can refer to changes in yaw movement, either alone or in combination with pitch movements. In stage 2802, the processor 214 of the control unit 102 sets the maximum slew rate to a predetermined pitch limit for the dynamic light pods 106 on the vehicle 502. In one form, the pitch limit is about 30 degrees per second, but it can be different in other examples. The control unit 102 in stage 2804 determines whether or not the system 100 is in a nominal state. Generally speaking, the system 100 can toggle between an inactive state where slew rate control is inactive and an active state where slew rate control is active. When in the nominal state, the control unit 102 in stage 2806 determines if the absolute value of the acceleration in the vertical direction (i.e., pitch or y-direction) from the accelerometer 122 is greater than an active threshold or limit that was predesignated. In other words, the control unit 102 determines whether or not the vehicle 502 has rapidly accelerated or decelerated over an active threshold level that signifies that adaptive slew rate control is required. When the active threshold in stage 2808 is exceeded, the control unit 102 sets the maximum slew rate equal to a calibrated maximum slew rate. The calibrated maximum slew rate can be experimentally determined and can vary depending on any number of conditions, such as the type of vehicle, environmental conditions, and/or other conditions. In one form, the calibrated maximum slew rate is about 0.05 degrees per second, but it can differ in other variations. The state for the active slew rate control is set to active in stage 2810, and the control unit 102 in stage 2812 sets the pitch for the light beam to the slew rate filtered pitch. In other words, the change in pitch of the beam of light is limited to the maximum slew rate set in the system 100 when it is detected that the vehicle 502 has accelerated or decelerated greater than a predetermined limit (in stage 2718). In one form, the slew rate filtered pitch is limited to 5 degrees per second. Any value calculated greater than this limit is clipped to or set at 5 degrees per second. It should be recognized that other limit values can be used. The process illustrated in FIG. 28 runs in a constant loop. After stage 2812, the control unit 102 returns to stage 2804.

Referring again to stage 2806, when the absolute value of the vehicle 502 in the vertical direction is less than or equal to the active threshold, the control unit 102 proceeds to stage 2812 such that the pitch for the light beams from the dynamic light pods 106 is changed based on the change in pitch of the vehicle 502 as measured by the accelerometer 122. When the active threshold is not exceeded in stage 2806, the slew rate control state (i.e., inactive or active) remains the same. This helps to provide stability by preventing the system 100 from constantly jumping between the active slew rate control state and inactive state. Again, after stage 2812, the processor 214 returns to stage 2804.

Referring again to stage 2804, when the state of the system 100 is not nominal, the processor 214 of the control unit 102 in stage 2814 determines whether or not the absolute value of the acceleration in the Y-direction as provided by the accelerometer 122 is greater than an inactive threshold. This evaluation in stage 2814 helps to reduce rapid toggling between the active and inactive slew rate control states. In essence, the inactive threshold acts as a buffer such that the state is only changed when the acceleration/deceleration is at or below this inactive threshold. When the value exceeds the inactive threshold, the control unit 102 in stage 2816 sets the maximum slew rate to the calibrated maximum slew rate, and the target pitch in stage 2812 is again set to the pitch that was determined based on the calibrated maximum slew rate. When the absolute value of the acceleration from the accelerometer 122 is less than or equal to the inactive threshold, the control unit 102 sets the state to inactive in stage 2818 and calculates the pitch in stage 2812 in the manner as described previously. Once more, the control unit 102 returns to stage 2804 after stage 2812. As should be recognized, this slew control technique illustrated in FIG. 28 not only can control pitch in the dynamic light pods 106, but this technique can be used to control yaw in the dynamic light pods 106.

The above described techniques of controlling light movement can be used in other examples. For instance, the slew rate control technique described with reference to FIG. 28 can be used to reduce the impact of sudden head or other body part movements for the head motion control system described with reference to FIGS. 2 and 3. This slew rate control technique can also dampen (or enhance) control movements for the lights from other types of mobile devices 116, such as smart/cell phones, and/or even the joystick 226. In one form, the operation of all of the dynamic light pods 106 are controlled in unison, but in other examples, the operation of individual light pods 106 can be controlled individually. For example, the direction, light intensity and/or color from one or more of the dynamic light pods 106 can be adjusted based on the particular conditions, either manually or automatically. As should be appreciated from the discussion above, the system 100 is designed to be easily retrofitted to pre-existing vehicles 502. For instance, the system 100 requires minimal interface with the sensor package of the vehicle 502 in order to function. As an example, the directional sensor 104 is designed to be easily retrofitted to a pre-existing steering apparatus 506. The harnessing and daisy chain capability of the system 100 also helps to simplify installation or retrofitting to pre-existing vehicles 502. While some of the components of the system 100 are illustrated in the drawings as being separate, it should be appreciated that one or more components of the system 100 can be integrated to form a single unit. For instance, all or part of the control unit 102 can be incorporated into one or more of the dynamic light pods 106. Conversely, some of the components illustrated as forming a single unit in the system 100 can be in the form of separate components. It also should be recognized that the mobile device 116 can function as both the input 118 and output 120 devices of the control unit 102 such that an individual is able to monitor and control the system 100 via the mobile device 116. For example, a user via a smart phone can manually adjust the position of the light shone from the dynamic light pods 106, change the sensitivity state, switch between automatic and manual modes, and perform other functions provided by the control unit 102.

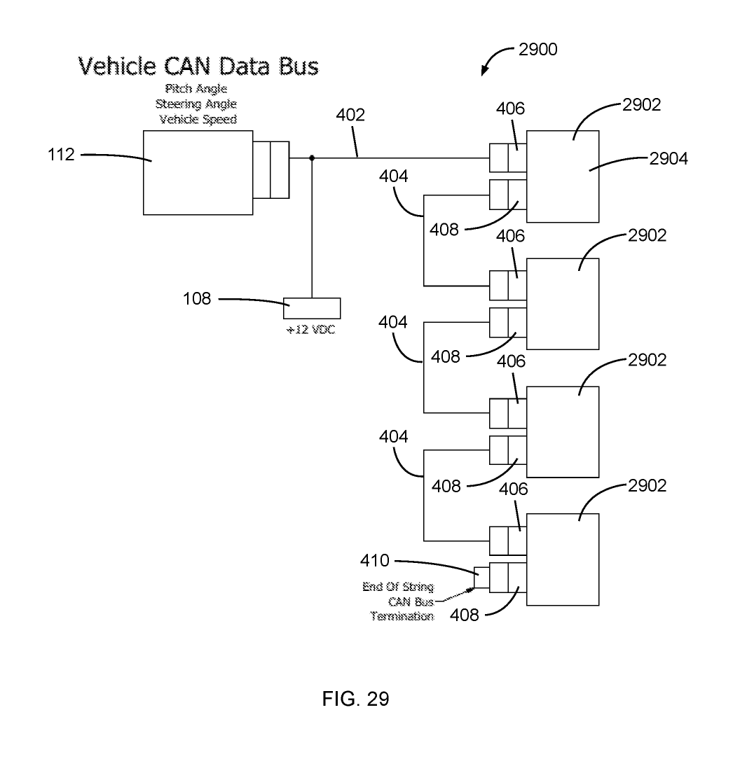

FIG. 29 is a block diagram of another example of a dynamic light system 2900. In this example, the system 2900 does not include a separate control unit 102, but rather, the functionality of the control unit 102 has been incorporated into one or more dynamic light pods 2902. As will be appreciated, the dynamic light pods 2902 have a number of features in common with the previously discussed dynamic light pods 106, and for the sake of brevity as well as clarity, these common features will not be discussed in detail, but reference is made to the previous discussion. For example, the dynamic light pods 2902 are powered by power source 108 in a fashion similar to that discussed before. As depicted, pitch angle, steering angle, and vehicle speed information is provided by the vehicle communication bus 112. The dynamic light pods 2902 are operatively connected to the vehicle communication bus 112 via the main harness 402 and pod harnesses 404. The dynamic light pods 2902 have input 406 and output 408 connectors to which the main harness 402 and/or pod harnesses 404 are connected. Like in the previous examples, the dynamic light pods 2902 are daisy chained together through the pod harnesses 404. This daisy chain arrangement created by the pod harnesses 404 is terminated by the CAN bus termination 410.

In one variation, a controller/peripheral type communication arrangement (sometimes referred to as a “master/slave” arrangement) is used to control the operation of the dynamic light pods 2902. For example, one of the dynamic light pods 2902, such as the one indicated by reference numeral 2904, can act as the control unit 102 (i.e., controller) for controlling the remaining (peripheral) dynamic light pods 2902. The controller dynamic light pod 2904 can be located elsewhere along the daisy chained dynamic light pods 2902 than is illustrated. To help simplify manufacturing, each of the dynamic light pods 2902 in one example can include the components required to act controller dynamic light pod 2904, and hardware, software, and/or firmware can be used to designate whether the individual dynamic pods 2902 act as the controller or peripheral device. In another example, the controller dynamic light pod 2904 can be physically different from the other dynamic light pods 2902, such as by incorporating additional or alternative components. For instance, the controller dynamic light pod 2904 is used in place of the control unit 102 by incorporating a solid-state type gyro/accelerometer 122 and the ability to accept data from the directional sensor 104, and the other remaining peripheral dynamic light pods 2902 are in the form of the previously described dynamic light pods 106 (see e.g., FIG. 21). In certain forms, the directional data from the directional sensor 104 and/or a combination of data from the vehicle communication bus 112 (e.g., speed, pitch, etc.) is passed to the other dynamic light pods 106. In one form, each dynamic light pod 2902 has its own vehicle communication bus interface 212. As long as the dynamic light pod 2902 has power, such as from the power source 108, and is on the vehicle communication bus 112, the dynamic light pod 2902 can receive, process, and follow the data from the controller 102, the vehicle communication bus 112, other dynamic light pods 2902, and/or the controller dynamic light pod 2904. In some designs, more than one controller dynamic light pod 2904 can be used. For instance, multiple controller dynamic light pods 2904 can be used for redundancy and/or to control localized clusters or groups of dynamic light pods 2902. In still other variations, the controller dynamic light pod 2904 can be dynamically assigned and/or changed over time, depending on any number of operating conditions and/or other factors.

Each dynamic light pod 2902 in other variations is independently controllable such that each one acts as their own, integrated control unit 102. In other words, each one is in the form of the controller dynamic light pod 2904, and the actions of the controller dynamic light pod 2904 are based on the firmware and/or software for the particular controller dynamic light pod 2904. In one form, each dynamic light pod 2902 incorporates a solid-state type gyro/accelerometer 122 and has the ability to accept data from the directional sensor 104, either directly or indirectly. Each dynamic light pod 2902 has its own vehicle communication bus interface 212. Incorporating the accelerometer 122 allows each dynamic light pod 2902 to know its orientation (e.g., which way is up) and can be mounted upside-down and/or at unconventional angles, and yet, the dynamic light pod 2902 is still able to compensate for the irregular orientation by correcting light movement independently of the mounting orientation of the dynamic light pod 2902. This configuration allows the dynamic light pod 2902 to be operated independently, or from any combination of control unit 102, vehicle communication bus interface 212, other dynamic light pod 2902, and/or self-generated data. As long as the dynamic light pod 2902 has power, such as from the power source 108, and is on the vehicle communication bus 112, the dynamic light pod 2902 can receive, process, and follow the data from the vehicle communication bus 112, and/or other dynamic light pods 2902.

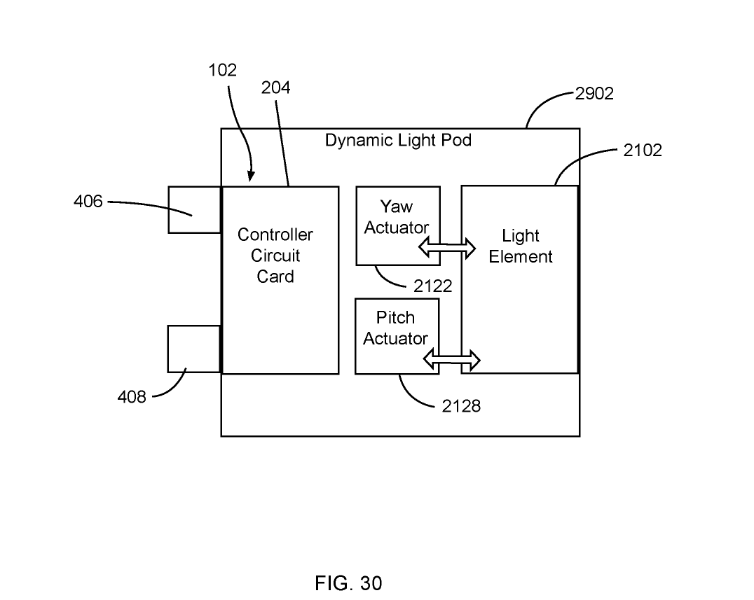

Each of the dynamic light pods 2902 in one example can include all (or most) of the components required to perform the functions of a controller or independently controllable dynamic light pod 2902. This helps simplify and streamline manufacturing because only one type of dynamic light pod 2902 needs to be manufactured. Hardware, software, and/or firmware modifications can be used to designate whether the individual dynamic pods 2902 act as the controller, peripheral, or independently controllable device. For example, software can be used to disable certain functions, such as the accelerometer/gyroscope, direction, and speed related functions, in all of the dynamic light pods 2902 acting as peripheral devices and maintaining these functions in the one or more dynamic light pods 2902 that act as the controller dynamic light pod 2904. When each dynamic light pod 2902 is configured for independent control, this functionality is not disabled so that each one is able to independently control itself. FIG. 30 is a block diagram that shows such an example of the dynamic light pod 2902. In this example, the dynamic light pod 2902 integrates the control unit 102. The dynamic light pod 2902 is constructed in a manner very similar to that illustrated in FIGS. 19-24. For instance, the dynamic light pod 2902 includes the input connector 406, the output connector 408, the light element 2102, the yaw actuator 2122, and the pitch actuator 2128 of the type described before. In this illustrated example, the circuit board 2134 of FIG. 21 has been replaced with the controller circuit card assembly 204 of the type illustrated in FIG. 2. In one form, the controller circuit card assembly 204 includes the wireless receiver/transmitter (or transceiver) 208, the solid-state three-axis gyroscope and three-axis accelerometer 210, the vehicle communication bus interface (or CAN data bus receiver/transmitter) 212, the processor 214, and the power supply 216 of the type previously described. If so configured, the controller circuit card assembly 204 can function as the control unit 102 for at least the dynamic light pod 2902 as well as for other dynamic light pods 106, 2902. The controller circuit card assembly 204 is operatively connected to the yaw actuator 2122 and the pitch actuator 2128 which in turn are mechanically linked to the light element 2102. Through the yaw 2122 and pitch 2128 actuators, the controller circuit card assembly 204 is able to control the yaw and pitch of the light element 2102 in a similar fashion to that described above with respect to FIGS. 19-24.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A system, comprising:
a directional sensor configured to sense direction of a vehicle;
a control unit operatively connected to the directional sensor to receive the direction of the vehicle from the directional sensor; and
a light pod operatively connected to the control unit, wherein the light pod includes an illumination element configured to provide light, wherein the light pod is configured to change direction of the light from the illumination element in response to a signal received from the control unit based at least in part on the direction of the vehicle sensed by the direction sensor.

2. The system of claim 1, further comprising:
the vehicle, wherein the vehicle has at least one headlight installed when the vehicle was originally manufactured; and
the light pod is separate from the headlight and attached after the vehicle was manufactured.

3. The system of claim 2, wherein the control unit is attached to the vehicle after the vehicle was originally manufactured.

4. The system of claim 1, wherein the light pod includes:
a gimbal to which the illumination element is secured,
a pitch actuator to pivot the illumination element in the gimbal in a pitch direction, and
a yaw actuator configured to pivot the illumination element in the gimbal in a yaw direction.

5. The system of claim 4, wherein the control unit is configured to activate the yaw actuator based at least in part on the direction of the vehicle sensed by the direction sensor.

6. The system of claim 4, further comprising:
an accelerometer/gyroscope operatively connected to the control unit to monitor acceleration of the vehicle; and
wherein the control unit is configured to adjust a slew rate of a signal sent to the pitch actuator upon the accelerometer/gyroscope sensing a rapid acceleration or deceleration to reduce sudden movement of the light from the light pod.

7. The system of claim 1, further comprising:
a speed sensor operatively connected to the control unit to sense speed of the vehicle; and
wherein the control unit is configured to adjust a rate at which the direction of the light moves based on the speed from the speed sensor.

8. The system of claim 7, further comprising:
a bus of the vehicle; and
wherein the speed sensor and the control unit are operatively connected via the bus.

9. The system of claim 1, further comprising:
a main harness operatively connecting the directional sensor and the light pod to the control unit.

10. The system of claim 9, further comprising:
a power source of the vehicle; and
wherein the main harness operatively connects the control unit to the power source of the vehicle to at least power the control unit and the light pod.

11. The system of claim 1, wherein the control unit is integrated into the light pod.

12. The system of claim 1, further comprising:
wherein the light pod is a first light pod; and
a second light pod operatively connected to the control unit.

13. The system of claim 12, wherein the second light pod is daisy chained to the first light pod.

14. The system of claim 12, further comprising:
a pod harness operatively connecting the first light pod to the second light pod.

15. The system of claim 12, wherein the first light pod is configured to control the second light pod.

16. The system of claim 12, wherein the first light pod and the second light pod are independently controllable.

17. The system of claim 1, wherein the light pod include a gyroscope to correct light movement independently of mounting orientation of the light pod.

18. The system of claim 1, wherein the control unit includes an input device to manually control the direction of the light from the light pod.

19. The system of claim 1, further comprising:
a transceiver operatively connected to the control unit; and
a mobile device wirelessly communicating with the control unit via the transceiver.

20. The system of claim 19, wherein the mobile device includes a cellphone configured to facilitate manual control of the light from the light pod.

21. The system of claim 19, wherein:
the mobile device is configured to be worn on a head of an individual; and
the control unit is configured to change the direction of the light from the light pod based at least in part on movement of the head sensed by the mobile device.

22. A system of claim 1, wherein the directional sensor includes a cable-extension transducer.

23. The system of claim 22, further comprising:
a steering shaft of the vehicle; and
wherein the directional sensor includes
a steering coupler coupled to the steering shaft, and
a cable extending between the steering coupler and the cable-extension transducer.

24. The system of claim 1, further comprising:
an input device to select a sensitivity level; and
the control unit is configured to adjust a rate at which the direction of the light is change at least based on the sensitivity level.

25. A method, comprising:
receiving a wireless signal from a mobile device indicating a direction of light with a control unit; and
changing the direction of the light shown from a light pod attached to a vehicle based on said receiving the wireless signal.

26. The method of claim 25, further comprising:
wherein the mobile device includes a wearable sensor worn on a head of an individual; and
wherein said changing the direction of the light includes synchronizing movement of the light from the light pod based on movement of the head sensed by the wearable sensor.

27. The method of claim 25, further comprising:
wherein the mobile device includes a cell phone; and
wherein said changing the direction of the light includes moving the light from the light pod based on movement of the cell phone.

28. The method of claim 25, further comprising:
wherein the mobile device includes an input device; and
wherein said changing the direction of the light includes moving the light from the light pod based on signals from the input device of the mobile device.

29. A method, comprising:
shining light with a light pod attached to a vehicle, wherein the light pod is operatively connected to a control unit that is operatively connected to an accelerometer;
detecting a motion of the vehicle with the control unit through the accelerometer;
changing the direction of the light shown from the light pod based on said detecting by sending a signal from the control unit to the light pod;
determining the motion of the vehicle exceeds a threshold with the control unit; and
adjusting a rate of change of the direction of the light shown from the light pod based on said determining.

30. The method of claim 29, wherein said determining the motion of the vehicle includes:
determining the accelerometer is in a nominal state;
determining an absolute value of acceleration of the accelerometer exceeds an active threshold limit;
setting a maximum slew rate to a calibrated maximum slew rate; and
wherein said adjusting the rate includes limiting the rate based on the maximum slew rate.

31. The method of claim 29, wherein said determining the motion of the vehicle includes:
determining the accelerometer is not in a nominal state;
determining an absolute value of acceleration of the accelerometer exceeds an inactive threshold limit;
setting a maximum slew rate to a calibrated maximum slew rate; and
wherein said adjusting the rate includes limiting the rate based on the maximum slew rate.

32. The method of claim 29, wherein said determining the motion of the vehicle includes:
determining the accelerometer is not in a nominal state;
determining an absolute value of acceleration of the accelerometer is less than or equal to an inactive threshold limit; and
setting a state of slew rate control to inactive.

33. The method of claim 29, further comprising:
receiving with the control unit a sensitivity control signal; and
adjusting the rate of change of the direction of the light shown from the light pod based on the sensitivity control signal.

34. The method of claim 29, further comprising:
determining a mounting orientation of the light pod with a gyroscope in the light pod; and
correcting movement the light shone from the light pod based on said determining the mounting orientation.

35. The method of claim 29, wherein the control unit is integrated into the light pod.

36. A method, comprising:
shining light with a first light pod and a second light pod that are attached to a vehicle;
controlling the light shone from the first light pod with the first light pod independently of the second light pod; and
controlling the light shone from the second light pod with the second light pod independently of the first light pod.

37. The method of claim 36, wherein said controlling the light shone from the first light pod includes changing direction of the light shone from the first light pod.

38. The method of claim 36, wherein said controlling the light shone from the first light pod includes changing directional movement of the light shone from the first light pod.

39. The method of claim 36, further comprising:
determining a mounting orientation of the second light pod with the second light pod; and
correcting movement the light shone from the second light pod based on said determining the mounting orientation.

40-72. (canceled)
